(19) United States
(12) Patent Application Publication
(10) Pub. No.: US 2023/0275728 A1
(43) Pub. Date: Aug. 31, 2023

(54) METHOD AND APPARATUS FOR TRANSMITTING AND RECEIVING UPLINK SIGNAL IN WIRELESS COMMUNICATION SYSTEM

(71) Applicant: LG ELECTRONICS INC., Seoul (KR)

(72) Inventors: Jaehoon CHUNG, Seoul (KR); Jiwon KANG, Seoul (KR); Seongwon GO, Seoul (KR)

(73) Assignee: LG ELECTRONICS INC., Seoul (KR)

(21) Appl. No.: 18/005,887

(22) PCT Filed: Aug. 6, 2021
(86) PCT No.: PCT/KR2021/010428

§ 371 Date: Jan. 18, 2023

(30) Foreign Application Priority Data
Aug. 7, 2020 (KR) 10-2020-0099511

(51) Int. Cl. H04L 5/00; H04W 52/14; H04W 52/24

(52) U.S. Cl. CPC H04L 5/0051; H04W 52/146; H04W 52/242

(57) ABSTRACT

A method and an apparatus for transmitting and receiving an uplink signal in a wireless communication system are disclosed. A method for transmitting an uplink signal according to one embodiment of the present disclosure may comprise the steps of: receiving, from a base station, configuration information related to transmission of the uplink signal; and transmitting the uplink signal to the base station on the basis of the configuration information. A spatial relation reference signal (RS) and a pathloss (PL) RS for the uplink signal are designated by means of the configuration information, and the uplink signal is transmitted through the same spatial domain transmission filter used for transmission and reception of the designated spatial relation RS, and the transmission power of the uplink signal may be determined on the basis of the designated PL RS.

### CROSS-REFERENCE TO RELATED APPLICATION(S)

This application is the National Stage filing under 35 U.S.C. 371 of International Application No. PCT/KR2021/010428, filed on Aug. 6, 2021, which claims the benefit of earlier filing date and right of priority to Korean Application No. 10-2020-0099511, filed on Aug. 7, 2020, the contents of which are all hereby incorporated by reference herein in their entireties.

### TECHNICAL FIELD

The present disclosure relates to a wireless communication system, and in more detail, relates to a method and an apparatus of transmitting and receiving an uplink signal in a wireless communication system.

### BACKGROUND

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### SUMMARY

A technical object of the present disclosure is to provide a method and an apparatus for transmitting and receiving an uplink signal.

In addition, an additional technical object of the present disclosure is to provide a method and an apparatus for configuring transmission parameters of an uplink signal (e.g., a transmission beam, a panel, a pathloss reference signal, etc. of an uplink signal of a terminal).

The technical objects to be achieved by the present disclosure are not limited to the above-described technical objects, and other technical objects which are not described herein will be clearly understood by those skilled in the pertinent art from the following description.

A method for transmitting an uplink signal in a wireless communication system according to an aspect of the present disclosure, may comprise steps of: receiving configuration information related to transmission of the uplink signal from a base station; and transmitting the uplink signal to the base station based on the configuration information. A spatial relation reference signal (RS) for the uplink signal and a pathloss (PL) RS for the uplink signal may be assigned by the configuration information, the uplink signal may be transmitted through the same spatial domain transmission filter used for transmission and reception of the assigned spatial relation RS, and a transmission power of the uplink signal may be determined based on the assigned PL RS.

A method for receiving an uplink signal in a wireless communication system according to an aspect of the present disclosure, may comprise steps of: transmitting configuration information related to transmission of the uplink signal to a terminal; and receiving the uplink signal from the terminal. A spatial relation reference signal (RS) for the uplink signal and a pathloss (PL) RS for the uplink signal may be assigned by the configuration information, the uplink signal may be transmitted through the same spatial domain transmission filter used for transmission and reception of the assigned spatial relation RS, and a transmission power of the uplink signal may be determined based on the assigned PL RS.

According to an embodiment of the present disclosure, signaling overhead may be reduced by configuring at least one of a transmission beam, a panel, and/or a pathloss reference signal for an uplink signal.

In addition, according to an embodiment of the present disclosure, at least one of a transmission beam, a panel, and/or a pathloss reference signal may be collectively changed/updated for uplink signals.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a structure of a wireless communication system to which the present disclosure may be applied.

FIG. 2 illustrates a frame structure in a wireless communication system to which the present disclosure may be applied.

FIG. 3 illustrates a resource grid in a wireless communication system to which the present disclosure may be applied.

FIG. 4 illustrates a physical resource block in a wireless communication system to which the present disclosure may be applied.

FIG. 5 illustrates a slot structure in a wireless communication system to which the present disclosure may be applied.

FIG. 6 illustrates physical channels used in a wireless communication system to which the present disclosure may be applied and a general signal transmission and reception method using them.

FIG. 7 is a diagram illustrating an uplink beam management operation using SRS in a wireless communication system to which the present disclosure may be applied.

FIG. 8 is a diagram illustrating an uplink beam management procedure in a wireless communication system to which the present disclosure may be applied.

FIG. 9 is a diagram illustrating a multi-panel UE in a wireless communication system to which the present disclosure may be applied.

FIG. 10 is a diagram illustrating a signaling procedure between a base station and a terminal for a method for transmitting and receiving an uplink signal according to an embodiment of the present disclosure.

FIG. 11 illustrates an operation of a terminal for transmitting an uplink signal according to an embodiment of the present disclosure.

FIG. 12 illustrates an operation of a base station for receiving an uplink signal according to an embodiment of the present disclosure.

FIG. 13 illustrates a block diagram of a wireless communication device according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB (evolved-NodeB), a gNB (Next Generation NodeB), a BTS (base transceiver system), an Access Point (AP), a Network (5G network), an AI (Artificial Intelligence) system/module, an RSU (road side unit), a robot, a drone (UAV: Unmanned Aerial Vehicle), an AR (Augmented Reality) device, a VR (Virtual Reality) device, etc. In addition, a terminal may be fixed or mobile, and may be substituted with a term such as a UE (User Equipment), an MS (Mobile Station), a UT (user terminal), an MSS (Mobile Subscriber Station), an SS(Subscriber Station), an AMS (Advanced Mobile Station), a WT (Wireless terminal), an MTC (Machine-Type Communication) device, an M2M (Machine-to-Machine) device, a D2D (Device-to-Device) device, a vehicle, an RSU (road side unit), a robot, an AI (Artificial Intelligence) module, a drone (UAV: Unmanned Aerial Vehicle), an AR (Augmented Reality) device, a VR (Virtual Reality) device, etc.

The following description may be used for a variety of radio access systems such as CDMA, FDMA, TDMA, OFDMA, SC-FDMA, etc. CDMA may be implemented by a wireless technology such as UTRA (Universal Terrestrial Radio Access) or CDMA2000. TDMA may be implemented by a radio technology such as GSM (Global System for Mobile communications)/GPRS (General Packet Radio Service)/EDGE (Enhanced Data Rates for GSM Evolution). OFDMA may be implemented by a radio technology such as IEEE 802.11 (Wi-Fi), IEEE 802.16 (WiMAX), IEEE 802-20, E-UTRA (Evolved UTRA), etc. UTRA is a part of a UMTS (Universal Mobile Telecommunications System). 3GPP (3rd Generation Partnership Project) LTE (Long Term Evolution) is a part of an E-UMTS (Evolved UMTS) using E-UTRA and LTE-A (Advanced)/LTE-A pro is an advanced version of 3GPP LTE. 3GPP NR(New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS (Technical Specification) 36.xxx Release 8. In detail, an LTE technology in or after 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36.211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38.211 (physical channels and modulation), TS 38.212 (multiplexing and channel coding), TS 38.213 (physical layer procedures for control), TS 38.214 (physical layer procedures for data), TS 38.300 (NR and NG-RAN(New Generation-Radio Access Network) overall description), TS 38.331 (radio resource control protocol specification) may be referred to.

Abbreviations of terms which may be used in the present disclosure is defined as follows.
BM: beam management
CQI: Channel Quality Indicator
CRI: channel state information-reference signal resource indicator
CSI: channel state information
CSI-IM: channel state information-interference measurement
CSI-RS: channel state information-reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block (including PSS (primary synchronization signal), SSS (secondary synchronization signal) and PBCH (physical broadcast channel))
TDM: time division multiplexing
TRP: transmission and reception point
TRS: tracking reference signal
Tx: transmission
UE: user equipment
ZP: zero power

Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB (enhanced mobile broadband communication), mMTC (massive MTC), URLLC (Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

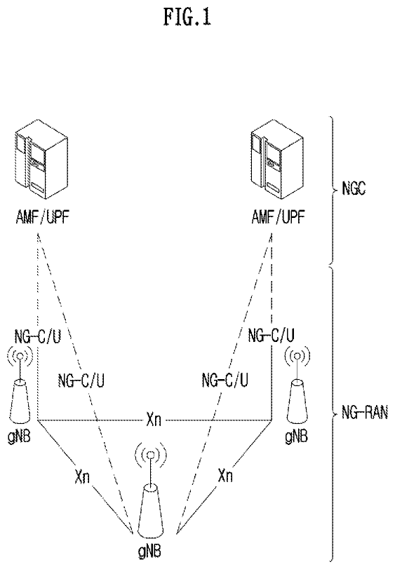

FIG. 1 illustrates a structure of a wireless communication system to which the present disclosure may be applied.

In reference to FIG. 1, NG-RAN is configured with gNBs which provide a control plane (RRC) protocol end for a NG-RA (NG-Radio Access) user plane (i.e., a new AS (access stratum) sublayer/PDCP (Packet Data Convergence Protocol)/RLC(Radio Link Control)/MAC/PHY) and UE. The gNBs are interconnected through a Xn interface. The gNB, in addition, is connected to an NGC(New Generation Core) through an NG interface. In more detail, the gNB is connected to an AMF (Access and Mobility Management Function) through an N2 interface, and is connected to a UPF (User Plane Function) through an N3 interface.

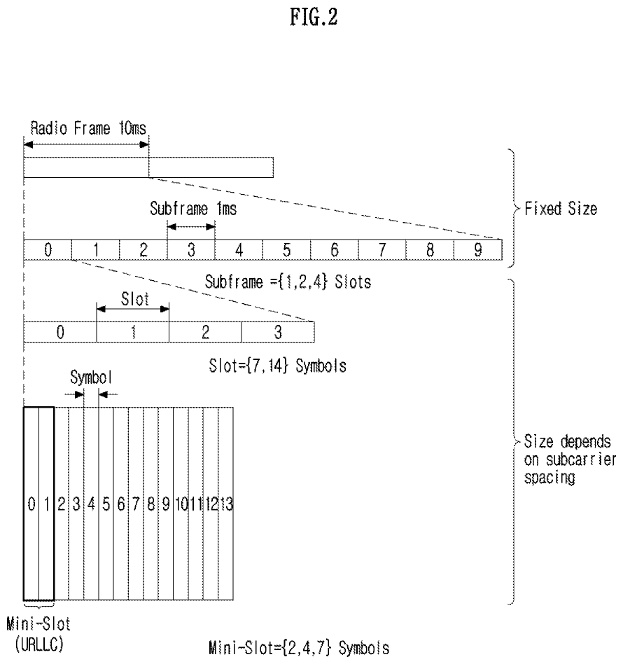

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, μ). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise. An NR frequency band is defined as a frequency range in two types (FR1, FR2). FR1, FR2 may be configured as in the following Table 2. In addition, FR2 may mean a millimeter wave (mmW).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

Regarding a frame structure in an NR system, a size of a variety of fields in a time domain is expresses as a multiple of a time unit of T_{c}=1/(Δfₘₐₓ·N_{f}). Here, Δfₘₐₓ is 480·10³ Hz and N_{f} is 4096. Downlink and uplink transmission is configured (organized) with a radio frame having a duration of T_{f}=1/(ΔfₘₐₓN_{f}/100)·T_{c}=10 ms. Here, a radio frame is configured with 10 subframes having a duration of T_{sf}=(ΔfₘₐₓN_{f}/1000)·T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration μ, slots are numbered in an increasing order of nₛ^{μ}∈{0, . . . , Nₛₗₒₜ^{subframe,μ}−1} in a subframe and are numbered in an increasing order of n_{s,f}^{μ}∈{0, . . . , Nₛₗₒₜ^{frame,μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that all OFDM symbols of a downlink slot or an uplink slot may not be used. Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

FIG. 2 is an example on μ=2 (SCS is 60 kHz), 1 subframe may include 4 slots referring to Table 3. 1 subframe={1,2,4} slot shown in FIG. 2 is an example, the number of slots which may be included in 1 subframe is defined as in Table 3 or Table 4. In addition, a mini-slot may include 2, 4 or 7 symbols or more or less symbols. Regarding a physical resource in a NR system, an antenna port, a resource grid, a resource element, a resource block, a carrier part, etc. may be considered. Hereinafter, the physical resources which may be considered in an NR system will be described in detail.

First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL (quasi co-located or quasi co-location) relationship. In this case, the large-scale property includes at least one of delay spread, doppler spread, frequency shift, average received power, received timing.

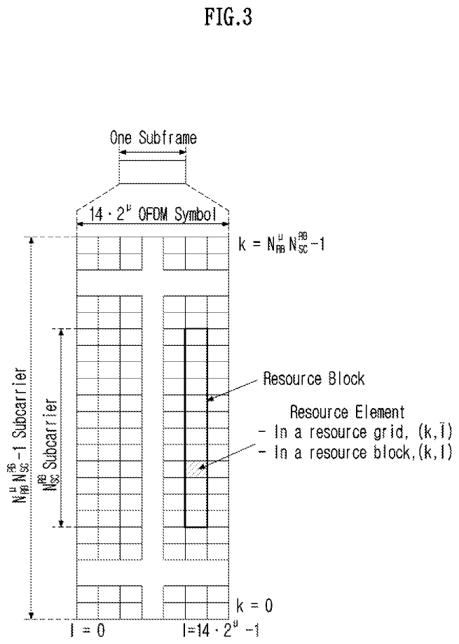

FIG. 3 illustrates a resource grid in a wireless communication system to which the present disclosure may be applied.

In reference to FIG. 3, it is illustratively described that a resource grid is configured with N_{RB}^{μ}N_{sc}^{RB} subcarriers in a frequency domain and one subframe is configured with 14.211 OFDM symbols, but it is not limited thereto. In an NR system, a transmitted signal is described by OFDM symbols of 2^{μ}N_{symb}^{(μ)} and one or more resource grids configured with N_{RB}^{μ}N_{sc}^{RB} subcarriers. Here, N_{RB}^{μ}<N_{RB}^{max,μ}. The N_{RB}^{max,μ} represents a maximum transmission bandwidth, which may be different between an uplink and a downlink as well as between numerologies. In this case, one resource grid may be configured per μ and antenna port p. Each element of a resource grid for μ and an antenna port p is referred to as a resource element and is uniquely identified by an index pair (k,l′). Here, k=0, . . . , N_{RB}^{μ}N_{sc}^{RB}−1 is an index in a frequency domain and l′=0, . . . , 2^{μ}N_{symb}^{(μ)}−1 refers to a position of a symbol in a subframe. When referring to a resource element in a slot, an index pair (k,l) is used. Here, l=0, . . . , N_{symb}^{μ}−1. A resource element (k,l′) for μ and an antenna port p corresponds to a complex value, a_{k,l′}^{(p,μ)}. When there is no risk of confusion or when a specific antenna port or numerology is not specified, indexes p and μ may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.
offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.
absoluteFrequencyPointA represents a frequency-position of point A expressed as in ARFCN (absolute radio-frequency channel number).

Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number n_{CRB}^{μ} and a resource element (k,l) for a subcarrier spacing configuration μ in a frequency domain is given as in the following Equation 1.

$${n}_{CRB}^{μ} = ⌊ \frac{k}{{N}_{sc}^{RB}} ⌋ \qquad [ Equation 1 ]$$

In Equation 1, k is defined relatively to point A so that k=0 corresponds to a subcarrier centering in point A. Physical resource blocks are numbered from 0 to N_{BWP,i}^{size,μ}−1 in a bandwidth part (BWP) and i is a number of a BWP. A relationship between a physical resource block n_{PRB} and a common resource block n_{CRB} in BWP i is given by the following Equation 2.

n_{CRB}^{μ}×n_{PRB}^{μ}+N_{BWP,i}^{start,μ} [Equation 2]

N_{BWP,i}^{start,μ} is a common resource block that a BWP starts relatively to common resource block 0.

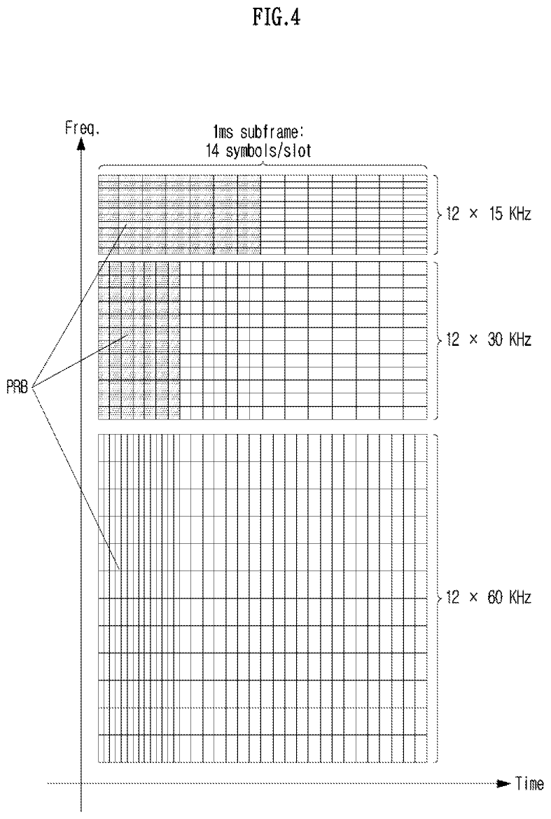

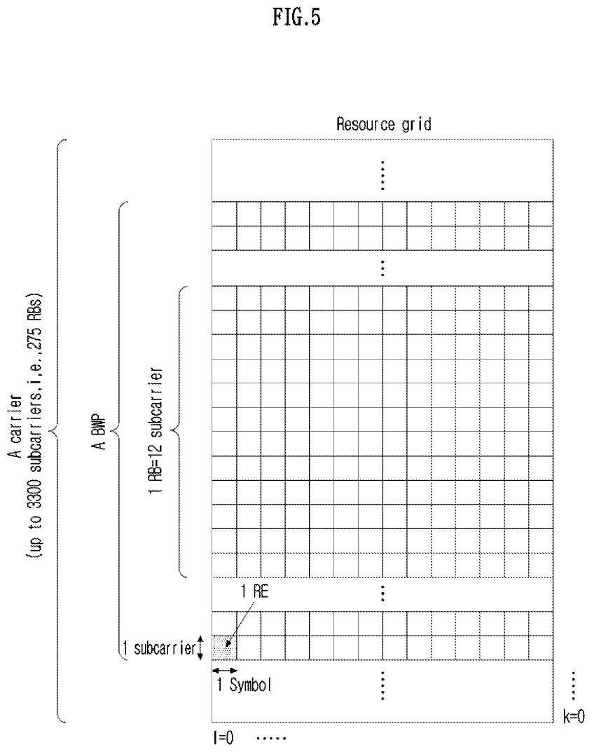

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP (Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE (Control Element) or RRC signaling, etc.). In addition, a base station may indicate switching to other configured DL/UL BWP (by L1 signaling or MAC CE or RRC signaling, etc.). Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

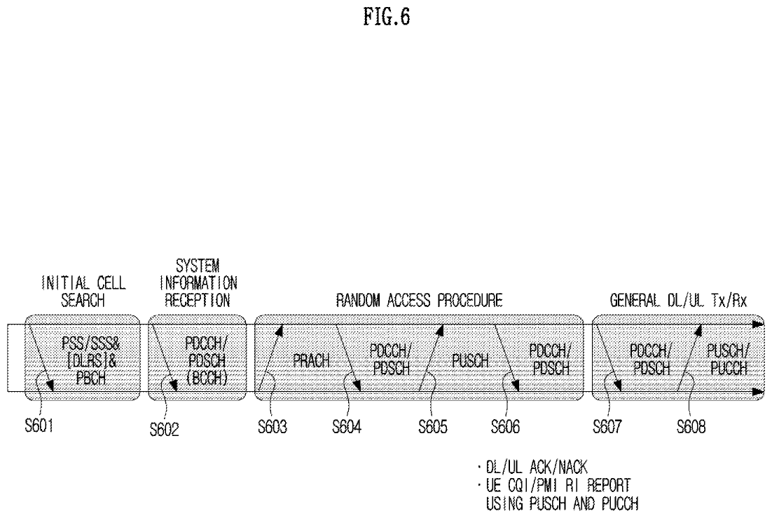

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH (Physical Uplink Shared Channel)/PUCCH (physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK (Acknowledgement/Non-Acknowledgement) signal, a CQI (Channel Quality Indicator), a PMI (Precoding Matrix Indicator), a RI (Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI Format | Use |
|---|---|
| 0_0 | Scheduling of a PUSCH in one cell |
| 0_1 | Scheduling of one or multiple PUSCHs in one |
| | cell, or indication of cell group downlink |
| | feedback information to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL (Supplementary UL), frequency resource allocation, time resource allocation, frequency hopping, etc.), information related to a transport block (TB) (e.g., MCS (Modulation Coding and Scheme), a NDI (New Data Indicator), a RV (Redundancy Version), etc.), information related to a HARQ (Hybrid—Automatic Repeat and request) (e.g., a process number, a DAI (Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined. DCI format 0_0 is used for scheduling of a PUSCH in one cell. Information included in DCI format 0_0 is CRC (cyclic redundancy check) scrambled by a C-RNTI (Cell Radio Network Temporary Identifier) or a CS-RNTI (Configured Scheduling RNTI) or a MCS-C-RNTI (Modulation Coding Scheme Cell RNTI) and transmitted.

DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI (Semi-Persistent CSI RNTI) or a MCS-C-RNTI and transmitted.

DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 1_0, 1_1 and 1_2 may include resource information (e.g., frequency resource allocation, time resource allocation, VRB (virtual resource block)-PRB (physical resource block) mapping, etc.), information related to a transport block (TB)(e.g., MCS, NDI, RV, etc.), information related to a HARQ (e.g., a process number, DAI, PDSCH-HARQ feedback timing, etc.), information related to multiple antennas (e.g., an antenna port, a TCI (transmission configuration indicator), a SRS (sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

Quasi-Co Location (QCL)

An antenna port is defined so that a channel where a symbol in an antenna port is transmitted can be inferred from a channel where other symbol in the same antenna port is transmitted. When a property of a channel where a symbol in one antenna port is carried may be inferred from a channel where a symbol in other antenna port is carried, it may be said that 2 antenna ports are in a QC/QCL (quasi co-located or quasi co-location) relationship.

Here, the channel property includes at least one of delay spread, doppler spread, frequency/doppler shift, average received power, received timing/average delay, or a spatial RX parameter. Here, a spatial Rx parameter means a spatial (Rx) channel property parameter such as an angle of arrival.

A terminal may be configured at list of up to M TCI-State configurations in a higher layer parameter PDSCH-Config to decode a PDSCH according to a detected PDCCH having intended DCI for a corresponding terminal and a given serving cell. The M depends on UE capability.

Each TCI-State includes a parameter for configuring a quasi co-location relationship between ports of one or two DL reference signals and a DM-RS (demodulation reference signal) of a PDSCH.

A quasi co-location relationship is configured by a higher layer parameter qcl-Type1 for a first DL RS and qcl-Type2 for a second DL RS (if configured). For two DL RSs, a QCL type is not the same regardless of whether a reference is a same DL RS or a different DL RS.

A QCL type corresponding to each DL RS is given by a higher layer parameter qcl-Type of QCL-Info and may take one of the following values.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, when a target antenna port is a specific NZP CSI-RS, it may be indicated/configured that a corresponding NZP CSI-RS antenna port is quasi-colocated with a specific TRS with regard to QCL-Type A and is quasi-colocated with a specific SSB with regard to QCL-Type D. A terminal received such indication/configuration may receive a corresponding NZP CSI-RS by using a doppler, delay value measured in a QCL-TypeA TRS and apply a Rx beam used for receiving QCL-TypeD SSB to reception of a corresponding NZP CSI-RS.

UE may receive an activation command by MAC CE signaling used to map up to 8 TCI states to a codepoint of a DCI field ‘Transmission Configuration Indication’.

Beam Management (BM)

A BM procedure is L1 (layer 1)/L2 (layer 2) procedures to obtain and maintain a set of beams of a base station (e.g., a gNB, a TRP, etc.) and/or terminal (e.g., a UE) beams which may be used for downlink (DL) and uplink (UL) transmission/reception, it may include the following procedures and terms.
Beam measurement: An operation that a base station or a UE measures a property of a received beamformed signal
Beam determination: An operation that a base station or a UE selects its Tx beam/Rx beam
Beam sweeping: An operation that a spatial region is covered by using a Tx and/or Rx beam for a certain time interval in a pre-determined method
Beam report: An operation that a UE reports information of a beamformed signal based on beam measurement

A BM procedure may be classified into (1) a DL BM procedure using a SS (synchronization signal)/PBCH (physical broadcast channel) Block or a CSI-RS and (2) an UL BM procedure using an SRS (sounding reference signal).

In addition, each BM procedure may include Tx beam sweeping for determining a Tx Beam and Rx beam sweeping for determining a Rx beam.

Hereinafter, uplink beam management will be described.

For UL BM, beam reciprocity (or beam correspondence) between a Tx beam and a Rx beam may be valid or may not be valid according to terminal implementation. If reciprocity between a Tx beam and a Rx beam is valid both in a base station and a terminal, a UL beam pair may be matched by a DL beam pair. But, when reciprocity between a Tx beam and a Rx beam is not valid in any one of a base station and a terminal, a process for determining a UL beam pair is required separately from a DL beam pair determination.

In addition, although both of a base station and a terminal maintain beam correspondence, a base station may use a UL BM procedure for determining a DL Tx beam without requesting a terminal to report a preferred beam.

UL BM may be performed through beamformed UL SRS transmission and whether UL BM of an SRS resource set is applied may be configured by a (higher layer parameter) usage. When a usage is configured as ‘BeamManagement (BM)’, only one SRS resource may be transmitted in each of a plurality of SRS resource sets in a given time instant.

A terminal may be configured with one or more SRS(Sounding Reference Symbol) resource sets configured by (a higher layer parameter) SRS-ResourceSet (through higher layer signaling, RRC signaling, etc.) For each SRS resource set, a UE may be configured with K≥1 SRS resources (a higher layer parameter SRS-resource). Here, K is a natural number and the maximum number of K is indicated by SRS capability.

Like DL BM, an UL BM procedure may be also classified into Tx beam sweeping of a terminal and Rx beam sweeping of a base station.

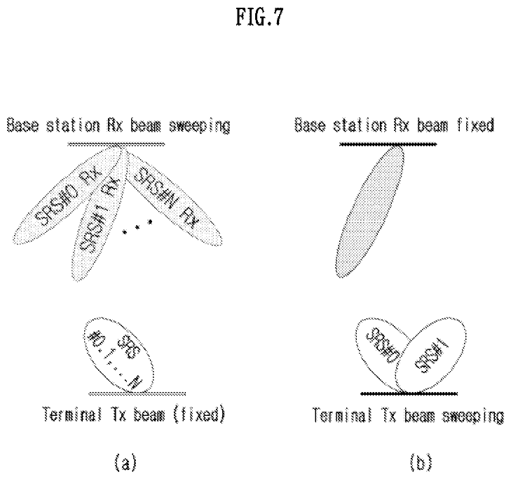

FIG. 7 is a diagram which illustrates an uplink beam management operation using SRS in a wireless communication system to which the present disclosure may be applied.

FIG. 7(a) illustrates a Rx beam determination operation of a base station and FIG. 7(b) illustrates a Tx beam sweeping operation of a terminal.

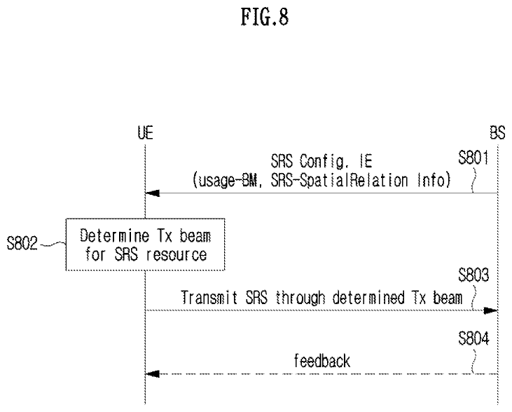

FIG. 8 is a diagram which illustrates an uplink beam management procedure in a wireless communication system to which the present disclosure may be applied.

A terminal receives RRC signaling (e.g., an SRS-Config IE) including a (higher layer parameter) usage parameter configured as ‘beam management’ from a base station (S801).

Table 6 represents an example of an SRS-Config IE (Information Element) and an SRS-Config IE is used for SRS transmission configuration. An SRS-Config IE includes a list of SRS-Resources and a list of SRS-ResourceSets. Each SRS resource set means a set of SRS-resources.

A network may trigger transmission of an SRS resource set by using configured aperiodicSRS-ResourceTrigger (L1 DCI).

TABLE 6
ASN1START
TAG-MAC-CELL-GROUP-CONFIG-START

| SRS-Config ::= | SEQUENCE { | |
|---|---|---|
| srs-ResourceSetToReleaseList | SEQUENCE | (SIZE(1..maxNrofSRS- |
| ResourceSets)) OF SRS-ResourceSetId | OPTIONAL, -- Need N | |
| srs-ResourceSetToAddModList | SEQUENCE | (SIZE(1..maxNrofSRS- |
| ResourceSets)) OF SRS-ResourceSet | OPTIONAL, -- Need N | |
| srs-ResourceToReleaseList | SEQUENCE (SIZE(1..maxNrofSRS-Resources)) | |
| OF SRS-ResourceId | OPTIONAL, -- Need N | |
| srs-ResourceToAddModList | SEQUENCE | (SIZE(1..maxNrofSRS- |

| | |
|---|---|
| Resources)) OF SRS-Resource | OPTIONAL, -- Need N |
| tpc-Accumulation | ENUMERATED {disabled} |
| | OPTIONAL, -- Need S |

...
}

| SRS-ResourceSet ::= | SEQUENCE { | |
|---|---|---|
| srs-ResourceSetId | SRS-ResourceSetId, | |
| srs-ResourceIdList | SEQUENCE | (SIZE(1..maxNrofSRS- |

| | |
|---|---|
| ResourcesPerSet)) OF SRS-ResourceId | OPTIONAL, -- Cond Setup |
| resourceType | CHOICE { |
| aperiodic | SEQUENCE { |
| aperiodicSRS-ResourceTrigger | INTEGER (1..maxNrofSRS-TriggerStates-1), |
| csi-RS | NZP-CSI-RS-ResourceId |

OPTIONAL, -- Cond NonCodebook

| | |
|---|---|
| slotOffset | INTEGER (1..32) |

OPTIONAL, -- Need S
...
},

| | |
|---|---|
| semi-persistent | SEQUENCE { |
| associatedCSI-RS | NZP-CSI-RS-ResourceId |

OPTIONAL, -- Cond NonCodebook
...
}

| | |
|---|---|
| periodic | SEQUENCE { |
| associatedCSI-RS | NZP-CSI-RS-ResourceId |

OPTIONAL, -- Cond NonCodebook
...
}
},

| | | |
|---|---|---|
| usage | ENUMERATED | {beamManagement, |

codebook, nonCodebook, antennaSwitching},

| | |
|---|---|
| alpha | Alpha |

OPTIONAL, -- Need S

| | |
|---|---|
| p0 | INTEGER (−202..24) |
| | OPTIONAL, -- Cond Setup |
| pathlossReferenceRS | CHOICE { |
| ssb-Index | SSB-Index, |
| csi-RS-Index | NZP-CSI-RS-ResourceId |
| SRS-SpatialRelationInfo ::= | SEQUENCE { |
| servingCellId | ServCellIndex |

OPTIONAL, -- Need S

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

}
}
}

| | |
|---|---|
| SRS-ResourceId ::= | INTEGER (0..maxNrofSRS- |

Resources-1)

In Table 6, usage represents a higher layer parameter which indicates whether an SRS resource set is used for beam management or is used for codebook-based or non-codebook-based transmission. A usage parameter corresponds to a L1 parameter ‘SRS-SetUse’. ‘spatialRelationInfo’ is a parameter which represents a configuration of a spatial relation between a reference RS and a target SRS. Here, a reference RS may be a SSB, a CSI-RS or a SRS corresponding to a L1 parameter ‘SRS-SpatialRelationInfo’. The usage is configured per SRS resource set.

A terminal determines a Tx beam for an SRS resource which will be transmitted based on SRS-SpatialRelation Info included in the SRS-Config IE (S802). Here, SRS-SpatialRelation Info is configured per SRS resource and represents whether the same beam as a beam used in a SSB, a CSI-RS or a SRS will be applied per SRS resource. In addition, SRS-SpatialRelationInfo may be configured or may not be configured for each SRS resource.

If SRS-SpatialRelationInfo is configured for an SRS resource, the same beam as a beam used in a SSB, a CSI-RS or a SRS is applied and transmitted. But, if SRS-SpatialRelationInfo is not configured for an SRS resource, the terminal randomly determines a Tx beam and transmits an SRS through the determined Tx beam (S803).

In more detail, for a P-SRS that ‘SRS-ResourceConfigType’ is configured as ‘periodic’:
i) when SRS-SpatialRelationInfo is configured as ‘SSB/PBCH’, a UE transmits a corresponding SRS resource by applying the same spatial domain transmission filter (or generated by a corresponding filter) as a spatial domain Rx filter used for SSB/PBCH reception; or
ii) when SRS-SpatialRelationInfo is configured as ‘CSI-RS’, a UE transmits a SRS resource by applying the same spatial domain transmission filter used for periodic CSI-RS or SP (semi-persistent) CSI-RS reception; or
iii) when SRS-SpatialRelationInfo is configured as ‘ SRS’, a UE transmits a corresponding SRS resource by applying the same spatial domain transmission filter used for periodic SRS transmission.

Although ‘SRS-ResourceConfigType’ is configured as ‘SP (semi-persistent)-SRS’ or ‘AP (aperiodic)-SRS’, a beam determination and transmission operation may be applied in a way similar to the above.

Additionally, a terminal may receive or may not receive a feedback on an SRS from a base station as in the following three cases (S804).
i) when Spatial_Relation_Info is configured for all SRS resources in a SRS resource set, a terminal transmits an SRS with a beam indicated by a base station. For example, when Spatial_Relation_Info indicates all the same SSB, CRI or SRI, a terminal repetitively transmits an SRS with the same beam. This case corresponds to FIG. 7(a) as a usage for a base station to select an Rx beam.
ii) Spatial_Relation_Info may not be configured for all SRS resources in an SRS resource set. In this case, a terminal may transmit with freely changing SRS beams. In other words, this case corresponds to FIG. 7(b) as a usage for a terminal to sweep Tx beams.
iii) Spatial_Relation_Info may be configured only for a part of SRS resources in an SRS resource set. In this case, for a configured SRS resource, an SRS may be transmitted with an indicated beam, and for a SRS resource that Spatial_Relation_Info is not configured an SRS may be transmitted by randomly applying a Tx beam by a terminal.

Multi Panel Operations

‘A panel’ referred to in the present disclosure may be interpreted/applied as ‘a plurality of (or at least one) panels’ or ‘a panel group’ (having a similarity/a common value from a viewpoint of a specific characteristic (e.g., timing advance (TA), a power control parameter, etc.)). Alternatively, ‘a panel’ referred to in the present disclosure may be interpreted/applied as ‘a plurality of (or at least one) antenna ports’ or ‘a plurality of (or at least one) uplink resources’ or ‘an antenna port group’ or ‘an uplink resource group (or set)’ (having a similarity/a common value from a viewpoint of a specific characteristic (e.g., TA, a power control parameter, etc.)). Alternatively, ‘a panel’ referred to in the present disclosure may be interpreted/applied as ‘a plurality of (or at least one) beams’ or ‘at least one beam group (or set)’ (having a similarity/a common value from a viewpoint of a specific characteristic (e.g., TA, a power control parameter, etc.)). Alternatively, ‘a panel’ referred to in the present disclosure may be defined as a unit for a terminal to configure a transmission/reception beam. For example, ‘a transmission panel’ may generate a plurality of candidate transmission beams in one panel, but it may be defined as a unit which may use only one beam of them in transmission at a specific time. In other words, only one transmission beam (spatial relation information RS) may be used per Tx panel to transmit a specific uplink signal/channel. In addition, ‘a panel’ in the present disclosure may refer to ‘a plurality of (or at least one) antenna ports’ or ‘an antenna port group’ or ‘an uplink resource group (or set)’ with common/similar uplink synchronization and may be interpreted/applied as an expression which is generalized as ‘an uplink synchronization unit (USU)’. In addition, ‘a panel’ in the present disclosure may be interpreted/applied as an expression which is generalized as ‘an uplink transmission entity (UTE)’.

In addition, the ‘uplink resource (or resource group)’ may be interpreted/applied as a PUSCH/PUCCH/SRS/PRACH resource (or resource group (or set)). In addition, the interpretation/application may be interpreted/applied conversely. In addition, ‘an antenna (or an antenna port)’ may represent a physical or logical antenna (or antenna port) in the present disclosure.

In other words, ‘a panel’ referred to in the present disclosure may be variously interpreted as ‘a terminal antenna element group’, ‘a terminal antenna port group’, ‘a terminal logical antenna group’, etc. In addition, for which physical/logical antennas or antenna ports will be combined and mapped to one panel, a variety of schemes may be considered by considering a position/a distance/a correlation between antennas, a RF configuration, and/or an antenna (port) virtualization scheme, etc. Such a mapping process may be changed according to terminal implementation. In addition, ‘a panel’ referred to in the present disclosure may be interpreted/applied as ‘a plurality of panels’ or ‘a panel group’ (having a similarity from a viewpoint of a specific characteristic).

Hereinafter, multi-panel structures will be described.

Terminal modeling which installs a plurality of panels (e.g., configured with one or a plurality of antennas) in terminal implementation in a high-frequency band (e.g., bi-directional two panels in 3GPP UE antenna modeling). A variety of forms may be considered in implementing a plurality of panels of such a terminal. Contents described below are described based on a terminal which supports a plurality of panels, but they may be extended and applied to a base station (e.g., a TRP) which supports a plurality of panels. The after-described contents related to multi-panel structures may be applied to transmission and reception of a signal and/or a channel considering multi panels described in the present disclosure.

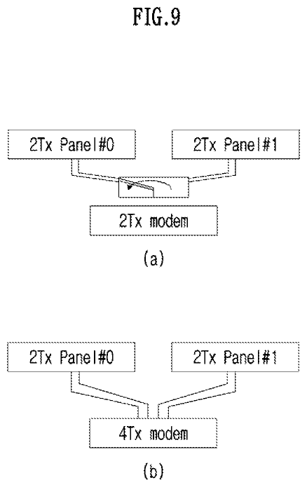

FIG. 9 is a diagram illustrating multi panel terminals in a wireless communication system to which the present disclosure may be applied.

FIG. 9(a) illustrates implementation of RF (radio frequency) switch-based multi panel terminals and FIG. 9(b) illustrates implementation of RF connection-based multi panel terminals.

For example, it may be implemented based on a RF switch as in FIG. 9(a). In this case, only one panel is activated for a moment and it may be impossible to transmit a signal for a certain duration of time to change an activated panel (i.e., panel switching).

For implementation of a plurality of panels in a different way, a RF chain may be connected respectively so that each panel can be activated anytime as in FIG. 9(b). In this case, time for panel switching may be 0 or too little. And, it may be possible to simultaneously transmit a signal by activating a plurality of panels at the same time (STxMP: simultaneous transmission across multi-panel) according to a model and power amplifier configuration.

For a terminal having a plurality of panels, a radio channel state may be different per panel, and in addition, a RF/antenna configuration may be different per panel, so a method in which a channel is estimated per panel is needed. In particular, a process in which one or a plurality of SRS resources are transmitted respectively per panel is needed to measure uplink quality or manage an uplink beam, or to measure downlink quality per panel or manage a downlink beam by utilizing channel reciprocity. Here, a plurality of SRS resources may be SRS resources which are transmitted by a different beam in one panel or may be SRS resources which are repeatedly transmitted by the same beam. Hereinafter, for convenience, a set of SRS resources transmitted in the same panel (a specific usage parameter (e.g., beam management, antenna switching, a codebook-based PUSCH, a non-codebook based PUSCH) and a specific time domain behavior (e.g., aperiodic, semi-persistent, or periodic)) may be referred to as an SRS resource group. For this SRS resource group, an SRS resource set configuration supported in a Rel-15 NR system may be utilized as it is or it may be configured separately by bundling one or a plurality of SRS resources (having the same time domain behavior and usage).

For reference, only when usage is beam management for the same usage and time domain behavior in Rel-15, a plurality of SRS resource sets may be configured. In addition, it is defined so that simultaneous transmission cannot be performed between SRS resources configured in the same SRS resource set, but simultaneous transmission can be performed between SRS resources belonging to a different SRS resource set. Accordingly, if panel implementation and simultaneous transmission of a plurality of panels as in FIG. 7(b) are considered, a corresponding concept (an SRS resource set) itself may be matched to an SRS resource group. But, an SRS resource group may be separately defined if even implementation (panel switching) as in FIG. 7(a) is considered. In an example, a configuration may be given by giving a specific ID to each SRS resource so that resources with the same ID belong to the same SRS resource group and resources with a different ID belong to a different resource group.

For example, it is assumed that 4 SRS resource sets configured for BM usage (RRC parameter usage is configured as ‘BeamManagement’) are configured to a UE. Hereinafter, for convenience, each is referred to as SRS resource set A, B, C, D. In addition, a situation is considered which applies implementation performing SRS transmission by corresponding each of the sets to one (Tx) panel because UE implements a total of 4 (Tx) Panels.

TABLE 7

| The maximum number | Additional limit |
|---|---|
| of SRS resource | to the maximum |
| sets across all time | number of the maximum |
| domain behaviors | SRS resource sets |
| (periodic/semi- | per supported time domain |
| persistent/aperiodic) | behavior (periodic/semi- |
| reported in 2-30 | persistent/aperiodic) |
| 1 | 1 |
| 2 | 1 |
| 3 | 1 |
| 4 | 2 |
| 5 | 2 |
| 6 | 2 |
| 7 | 4 |
| 8 | 4 |

In Rel-15 standards, such UE implementation is more clearly supported by the following agreement. In other words, for a UE which performs capability reporting for a value reported in feature group (FG) 2-30 as 7 or 8 in Table 7, a total of up to 4 SRS resource sets for BM (per supported time domain behavior) may be configured as in the right column of Table 7. As above, implementation which performs transmission by corresponding one UE panel to each set may be applied.

Here, when 4 panel UE corresponds each panel to one SRS resource set for BM and transmits it, the number itself of configurable SRS resources per each set is also supported by separate UE capability signaling. For example, it is assumed that 2 SRS resources are configured in the each set. It may correspond to ‘the number of UL beams’ which may be transmitted per panel. In other words, the UE may respectively correspond 2 UL beams to 2 configured SRS resources per each panel and transmit them when 4 panels are implemented. In this situation, according to Rel-15 standards, one of a codebook (CB)-based UL or non-codebook (NCB)-based UL mode may be configured for final UL PUSCH transmission scheduling. In any case, only one SRS resource set (having usage set as “CB-based UL” or “NCB-based UL”) configuration, i.e., only one dedicated SRS resource set (for a PUSCH) configuration, is supported in Rel-15 standards.

Hereinafter, multi panel UE (MPUE) categories will be described.

Regarding the above-described multi panel operations, the following 3 MPUE categories may be considered. Specifically, 3 MPUE categories may be classified according to i) whether multiple panels may be activated and/or ii) transmission using multiple panels may be possible.
i) MPUE category 1: In a terminal that multiple panels are implemented, only one panel may be activated at a time. A delay for panel switching/activation may be configured as [X]ms. In an example, the delay may be configured to be longer than a delay for beam switching/activation and may be configured in a unit of a symbol or in a unit of a slot. MPUE category 1 may correspond to MPUE-assumption) described in standardization-related documents (e.g., a 3gpp agreement, a technical report (TR) document and/or a technical specification (TS) document, etc.).
ii) MPUE category 2: In a terminal that multiple panels are implemented, multiple panels may be activated at a time. One or more panels may be used for transmission. In other words, simultaneous transmission using panels may be performed in a corresponding category. MPUE category 2 may correspond to MPUE-assumption2 described in standardization-related documents (e.g., a 3gpp agreement, a TR document and/or a TS document, etc.).
iii) MPUE category 3: In a terminal that multiple panels are implemented, multiple panels may be activated at a time, but only one panel may be used for transmission. MPUE category 3 may correspond to MPUE-assumption3 described in standardization-related documents (e.g., a 3gpp agreement, a TR document and/or a TS document, etc.).

Regarding multi panel-based signal and/or channel transmission and reception suggested in the present disclosure, at least one of the above-described 3 MPUE categories may be supported. In an example, in Rel-16, MPUE category 3 of the following 3 MPUE categories may be (selectively) supported.

In addition, information on a MPUE category may be predefined in specifications (i.e., standards). Alternatively, information on a MPUE category may be configured semi-statically and/or may be indicated dynamically according to a system situation (i.e., a network aspect, a terminal aspect). In this case, a configuration/an indication, etc. related to multi panel-based signal and/or channel transmission and reception may be configured/indicated by considering a MPUE category.

Hereinafter, a configuration/an indication related to panel-specific transmission/reception will be described.

Regarding a multi panel-based operation, signal and/or channel transmission and reception may be performed in a panel-specific way. Here, being panel-specific may mean that signal and/or channel transmission and reception in a unit of a panel may be performed. Panel-specific transmission and reception may be referred to as panel-selective transmission and reception.

Regarding panel-specific transmission and reception in a multi panel-based operation suggested in the present disclosure, a method of using identification information (e.g., an identifier (ID), an indicator, etc.) for configuring and/or indicating a panel which will be used for transmission and reception among one or more panels may be considered.

In an example, an ID for a panel may be used for panel-selective transmission of a PUSCH, a PUCCH, an SRS, and/or a PRACH among activated multiple panels. The ID may be configured/defined based on at least any one of the following 4 methods (options (Alts) 1, 2, 3, 4).
i) Alt.1: An ID for a panel may be an SRS resource set ID.

In an example, it may be desirable to correspond each UE Tx panel to an SRS resource set configured in terms of terminal implementation when considering a) an aspect that SRS resources of multiple SRS resource sets having the same time domain behavior are simultaneously transmitted in the same BWP, b) an aspect that a power control parameter is configured in a unit of an SRS resource set, c) an aspect that a terminal may report up to 4 SRS resource sets (they may correspond to up to 4 panels) according to a supported time domain behavior. In addition, an Alt.1 scheme has an advantage that an SRS resource set related to each panel may be used for ‘codebook’ and ‘non-codebook’-based PUSCH transmission. In addition, for an Alt.1 scheme, multiple SRS resources belonging to multiple SRS resource sets may be selected by extending an SRI (SRS resource indicator) field of DCI. In addition, a mapping table of an SRI to SRS resource may need to be extended to include SRS resources in the whole SRS resource set.
ii) Alt.2: An ID for a panel may be an ID which is (directly) associated with a reference RS resource and/or a reference RS resource set.
ii) Alt.3: An ID for a panel may be an ID which is directly associated with a target RS resource (a reference RS resource) and/or a reference RS resource set.

An Alt.3 scheme has an advantage that configured SRS resource set(s) corresponding to one UE Tx panel may be controlled more easily and that the same panel identifier may be allocated to multiple SRS resource sets having a different time domain behavior.
iv) Alt.4: An ID for a panel may be an ID which is additionally configured to spatial relation information (e.g., RRC_SpatialRelationInfo).

An Alt.4 scheme may be a scheme which newly adds information for representing an ID for a panel. In this case, it has an advantage that configured SRS resource sets corresponding to one UE Tx panel may be controlled more easily and that the same panel identifier may be allocated to multiple SRS resource sets having a different time domain behavior.

In an example, a method of introducing an UL TCI similarly to the existing DL TCI (Transmission Configuration Indication) may be considered. Specifically, definition of a UL TCI state may include a list of reference RS resources (e.g., an SRS, a CSI-RS and/or an SSB). A current SRI field may be reused to select a UL TCI state from a configured set or a new DCI field of DCI format 0_1 (e.g., a UL-TCI field) may be defined for a corresponding purpose.

Information related to the above-described panel-specific transmission and reception (e.g., a panel ID, etc.) may be transmitted by higher layer signaling (e.g., a RRC message, MAC-CE, etc.) and/or lower layer signaling (e.g., layer1 (L1: Layer1) signaling, DCI, etc.). Corresponding information may be transmitted from a base station to a terminal or may be transmitted from a terminal to a base station according to a situation or if necessary.

In addition, corresponding information may be configured by a hierarchical method which configures a set for a candidate group and indicates specific information.

In addition, the above-described identification information related to a panel may be configured in a unit of a single panel or in a unit of multiple panels (e.g., a panel group, a panel set).

Hereinafter, a panel/beam indication related method will be described.

In Rel-15 NR, spatial relation information (i.e., higher layer parameter spatialRelationInfo) may be used to configure/indicate a transmission beam to be used when a base station transmits a UL channel to a terminal. The base station may configure/indicate DL RS (i.e., SSB resource indicator (SSB-RI), CSI-RS resource indicator (CRI)(periodic (P)/semi-persistent (SP)/aperiodic (AP)) or SRS (i.e., SRS resource) as a reference RS for the target UL channel and/or target RS through RRC configuration. Through this, which UL transmission beam (i.e., spatial Tx parameter) to use may be configured/indicated when a corresponding UE transmits PUCCH and SRS. In addition, when the base station schedules the PUSCH to the terminal, the SRS transmission beam indicated by the base station may be indicated as a transmission beam for PUSCH transmission through an SRS resource indication (SRI) field of the UL grant DCI. In addition, the indicated SRS transmission beam may be used as the PUSCH transmission beam of the UE.

In addition, there are two UL MIMO transmission schemes for PUSCH transmission of Rel-15 NR, a codebook based (CB) UL transmission scheme and a non-codebook based (NCB) UL transmission scheme may be considered.

Hereinafter, in the present disclosure, “transmission of an SRS resource set” may be used in the same meaning as “transmission of an SRS based on information configured in an SRS resource set”. In addition, “transmitting an SRS resource” or “transmitting SRS resources” may be used in the same meaning as “transmitting an SRS or SRSs based on information configured in an SRS resource”.

In the case of the CB UL transmission scheme, the base station may first configure and/or indicate the terminal an SRS resource set for the purpose (e.g., usage) of ‘CB’, and the terminal may transmit the SRS based on any n-port SRS resource in the corresponding SRS resource set. The base station may acquire/obtain UL channel related information based on the corresponding SRS transmission, and may utilize the UL channel related information for PUSCH scheduling of the terminal.

After that, the base station may perform PUSCH scheduling through the UL DCI, and may indicate the SRS resource for the purpose of ‘CB’, which was previously used for SRS transmission of the terminal, through the SRI field of the DCI. Accordingly, the base station may indicate a PUSCH transmission beam of the terminal. In addition, the base station may indicate an uplink codebook through a transmit precoding matrix indicator (TPMI) field of the UL DCI, and accordingly, the base station may indicate the UL rank and the UL precoder to the terminal. The corresponding terminal may perform PUSCH transmission as indicated by the base station.

In the case of the NCB UL transmission scheme, the base station may first configure and/or indicate the terminal an SRS resource set for the purpose (e.g., usage) of ‘non-CB’. In addition, the terminal may determine a precoder to be applied in SRS resources in the corresponding SRS resource set (up to 4 resources, 1 port per resource) based on reception of the NZP CSI-RS linked/associated with the corresponding SRS resource set. The terminal may simultaneously transmit SRS based on corresponding SRS resources based on the determined precoder. Then, the base station may perform PUSCH scheduling through the UL DCI, and may indicate some of the SRS resources for the purpose of ‘non-CB’ previously used for SRS transmission of the terminal through the SRI field of the DCI. Accordingly, The base station may indicate the PUSCH transmission beam of the terminal. At the same time, the base station may indicate a UL rank and a UL precoder through the SRI field. The corresponding terminal may perform PUSCH transmission as indicated by the base station.

Hereinafter, examples of method(s) for indicating a panel and/or a beam of a terminal in uplink transmission that may be considered in a next-generation wireless communication system (e.g., NR system) will be described.

A base station (gNB) may configure/indicate panel-specific transmission for UL transmission, via:
Alt.2: The UL-TCI framework in Rel-16 is introduced, and UL-TCI is supported based on signaling similar to the DL beam indication supported in Rel-15.

Here, a new panel ID may or may not be introduced. Panel specific signaling is performed using the UL-TCI state.
Alt.3: A new panel-ID is introduced, which implicitly transmits for a target RS resource or resource set, for a PUSCH resource, for an SRS resource, and for a physical random access channel (PRACH) may be applied implicitly/explicitly.

Here, panel specific signaling is performed either implicitly (e.g., by DL beam reporting enhancement) or explicitly using the new panel-ID.

If explicitly signaled, the ID may be configured in target RS/channel or reference RS (e.g., in DL RS resource configuration or spatial relation info).

A new MAC CE is not defined for the purpose of introducing an ID.

Table 8 illustrates the UL-TCI states in Alt.2.

TABLE 8

| Valid | | | |
|---|---|---|---|
| UL-TCI | | | |
| state | Source | (target) | |
| configuration | (reference) RS | UL RS | [qcl-Type] |
| 1 | (for BM) SRS | DM-RS for | Spatial- |
| | resource + [panel | PUCCH or | relation |
| | ID] | SRS for | |
| | | PRACH | |
| 2 | DL RS(CSI-RS | DM-RS for | Spatial- |
| | resource or SSB) + | PUCCH or | relation |
| | [panel ID] | SRS for | |
| | | PRACH | |
| 3 | DL RS(CSI-RS | DM-RS for | Spatial- |
| | resource or SSB) + | PUSCH | relation + |
| | [panel ID] | | [port(s)- |
| | | | indication] |
| 4 | DL RS(CSI-RS | DM-RS for | Spatial- |
| | resource or SSB) | PUSCH | relation + |
| | and SRS resource + | | [port(s)- |
| | [panel ID] | | indication] |
| 5 | SRS resource + | DM-RS for | Spatial- |
| | [panel ID] | PUSCH | relation + |
| | | | [port(s)- |
| | | | indication] |
| 6 | UL RS(SRS for | DM-RS for | Spatial- |
| | BM) | PUSCH | relation + |
| | and SRS resource + | | [port(s)- |
| | [panel ID] | | indication] |

In addition, as described above, an unified framework for the base station to indicate a transmission panel/beam in the UL RS and/or UL channel of the terminal may be considered. For example, the framework may be referred to as ‘UL-TCI framework’ for convenience of description. The UL-TCI framework may be a form in which the DL-TCI framework considered in the existing (e.g., Rel-15 NR system) is extended to UL. When based on the UL-TCI framework, the base station may configure DL RS (e.g., SSB-RI, CRI) and/or UL RS (e.g., SRS) to the terminal through higher layer signaling (e.g., RRC configuration) as a reference RS or source RS to be utilized/applied as a transmission beam for a target UL channel (e.g., PUCCH, PUSCH, PRACH) and/or a target UL RS (e.g., SRS). Accordingly, the corresponding terminal may utilize the transmission beam of the reference RS or source RS configured by the base station, when transmitting the corresponding target UL RS and/or target UL channel.

When the above-described UL-TCI framework is applied, compared to the SRI-based PUSCH scheduling and PUSCH beam indication method, in which SRS for the purpose of ‘CB’ or ‘non-CB’ shall be transmitted before SRI indication for PUSCH transmission, there is an advantage in that overhead and delay for PUSCH beam configuration and/or indication may be reduced. In addition, the method based on the UL-TCI framework has the advantage of being collectively applied to all UL RS/channels such as PUCCH/PUSCH/PRACH/SRS.

Sounding Reference Signal (SRS)

In Rel-15 NR, spatialRelationInfo may be used in order for a base station to indicate to a terminal a transmission beam which will be used when transmitting an UL channel. A base station may indicate which UL transmission beam will be used when transmitting a PUCCH and an SRS by configuring a DL reference signal (e.g., an SSB-RI (SB Resource Indicator), a CRI (CSI-RS Resource Indicator)(P/SP/AP: periodic/semi-persistent/aperiodic)) or an SRS (i.e., an SRS resource) as a reference RS for a target UL channel and/or a target RS through a RRC configuration. In addition, when a base station schedules a PUSCH to a terminal, a transmission beam which is indicated by a base station and used for SRS transmission is indicated as a transmission beam for a PUSCH through an SRI field and used as a PUSCH transmission beam of a terminal.

Hereinafter, a SRS for a codebook (CB) and a non-codebook (NCB) will be described.

First, for a CB UL, a base station may first configure and/or indicate transmission of an SRS resource set for ‘a CB’ to a terminal. In addition, a terminal may transmit any n port SRS resource in a corresponding SRS resource set. A base station may receive a UL channel based on corresponding SRS transmission and use it for PUSCH scheduling of a terminal. Subsequently, a base station may indicate a PUSCH (transmission) beam of a terminal by indicating a SRS resource for ‘a CB’ which is previously transmitted by a terminal through a SRI field of DCI when performing PUSCH scheduling through UL DCI. In addition, a base station may indicate an UL rank and an UL precoder by indicating an uplink codebook through a TPMI (transmitted precoder matrix indicator) field. Thereby, a terminal may perform PUSCH transmission according to a corresponding indication.

Next, for a NCB UL, a base station may first configure and/or indicate transmission of an SRS resource set for ‘a non-CB’ to a terminal. In addition, a terminal may simultaneously transmit corresponding SRS resources by determining a precoder of SRS resources (up to 4 resources, 1 port per resource) in a corresponding SRS resource set based on reception of a NZP CSI-RS associated with a corresponding SRS resource set. Subsequently, a base station may indicate a PUSCH (transmission) beam of a terminal and an UL rank and an UL precoder at the same time by indicating part of SRS resources for ‘a non-CB’ which are previously transmitted by a terminal through an SRI field of DCI when performing PUSCH scheduling through UL DCI. Thereby, a terminal may perform PUSCH transmission according to a corresponding indication.

Hereinafter, an SRS for beam management will be described.

An SRS may be used for beam management. Specifically, UL BM may be performed by beamformed UL SRS transmission. Whether UL BM of an SRS resource set is applied is configured by (a higher layer parameter) ‘usage’. When usage is configured as ‘BeamManagement (BM)’, only one SRS resource may be transmitted to each of a plurality of SRS resource sets in a given time instant. A terminal may be configured with one or more Sounding Reference Symbol (SRS) resource sets configured by (a higher layer parameter) ‘SRS-ResourceSet’ (through higher layer signaling, e.g., RRC signaling, etc.). For each SRS resource set, UE may be configured with K≥1 SRS resources (a higher layer parameter, ‘SRS-resource’). Here, K is a natural number and the maximum value of K is indicated by SRS capability.

Hereinafter, an SRS for antenna switching will be described.

An SRS may be used for acquisition of DL CSI (Channel State Information) information (e.g., DL CSI acquisition). In a specific example, a BS (Base station) may measure an SRS from UE after scheduling transmission of an SRS to UE (User Equipment) under a situation of a single cell or in multi cells (e.g., carrier aggregation (CA)) based on TDD. In this case, a base station may perform scheduling of a DL signal/channel to UE based on measurement by an SRS by assuming DL/UL reciprocity. Here, regarding SRS-based DL CSI acquisition, an SRS may be configured for antenna switching.

In an example, when following standards (e.g., 3gpp TS38.214), usage of an SRS may be configured to a base station and/or a terminal by using a higher layer parameter (e.g., usage of a RRC parameter, SRS-ResourceSet). Here, usage of a SRS may be configured as usage of beam management, usage of codebook transmission, usage of non-codebook transmission, usage of antenna switching, etc.

Hereinafter, a case in which SRS transmission (i.e., transmission of an SRS resource or an SRS resource set) is configured for antenna switching among the usages will be specifically described.

In an example, for a terminal with partial reciprocity, SRS transmission based on antenna switching (i.e., transmission antenna switching) may be supported for DL (downlink) CSI (Channel State Information) acquisition through SRS transmission under a situation such as TDD (Time Division Duplex). When antenna switching is applied, about 15 μs may be generally needed between SRS resources (and/or resources between a SRS resource and a PUSCH/a PUCCH) for antenna switching of a terminal. By considering it, (the minimum) guard period as in the following Table 11 may be defined.

TABLE 9

| μ | Δf = 2^{μ} · 15 [kHz] | Y [Symbol] |
|---|---|---|
| 0 | 15 | 1 |
| 1 | 30 | 1 |
| 2 | 60 | 1 |
| 3 | 120 | 2 |

In Table 9, μ represents numerology, Δf represents subcarrier spacing and Y represents the number of symbols of a guard period, i.e., a length of a guard period. In reference to Table 11, the guard period may be configured based on a parameter μ which determines numerology. In the guard period, a terminal may be configured not to transmit any other signal and the guard period may be configured to be used fully for antenna switching. In an example, the guard period may be configured by considering SRS resources transmitted in the same slot. In particular, when a terminal is configured and/or indicated to transmit an aperiodic SRS configured by intra-slot antenna switching, a corresponding terminal may transmit an SRS on each assigned SRS resource by using a different transmission antenna and the above-described guard period may be configured between each resource.

In addition, as described above, when a terminal is configured with an SRS resource and/or an SRS resource set configured for antenna switching through higher layer signaling, a corresponding terminal may be configured to perform SRS transmission based on UE capability related to antenna switching. In this case, UE capability related to antenna switching may be ‘1T2R’, ‘2T4R’, ‘1T4R’, ‘1T4R/2T4R’, ‘1T1R’, ‘2T2R’, ‘4T4R’, etc. Here, ‘mTnR’ may mean UE capability which supports m transmission and n reception.

(Example S1) For example, for a terminal which supports 1T2R, up to 2 SRS resource sets may be configured as a different value for resourceType of a higher layer parameter SRS-ResourceSet. In this case, each SRS resource set may have 2 SRS resources transmitted in different symbols and each SRS resource may configure a single SRS port in a given SRS resource set. In addition, an SRS port for a second SRS resource in an SRS resource set may be configured to be associated with a UE antenna port different from an SRS port for a first SRS resource in the same SRS resource set.

(Example S2) In another example, for a terminal which supports 2T4R, up to 2 SRS resource sets may be configured as a different value for resourceType of a higher layer parameter SRS-ResourceSet. Here, each SRS resource set may have 2 SRS resources transmitted in different symbols and each SRS resource may configure 2 SRS ports in a given SRS resource set. In addition, an SRS port pair for a second SRS resource in an SRS resource set may be configured to be associated with a UE antenna port different from an SRS port pair for a first SRS resource in the same SRS resource set.

(Example S3) In another example, for a terminal which supports 1T4R, SRS resource sets may be configured by a different scheme according to whether SRS transmission is configured as periodic, semi-persistent and/or aperiodic. First, when SRS transmission is configured as periodic or semi-persistent, 0 SRS resource set configured or 1 SRS resource set configured with 4 SRS resources based on resourceType of a higher layer parameter SRS-ResourceSet may be configured to be transmitted in different symbols. Here, each SRS resource may configure a single SRS port in a given SRS resource set. In addition, an SRS port for each SRS resource may be configured to be associated with a different UE antenna port. On the other hand, when SRS transmission is configured as aperiodic, 0 SRS resource set configured or 2 SRS resource sets configured with a total of 4 SRS resources based on resourceType of a higher layer parameter SRS-ResourceSet may be configured to be transmitted in different symbols of 2 different slots. Here, a SRS port for each SRS resource in 2 given SRS resource sets may be configured to be associated with a different UE antenna port.

(Example S4) In another example, for a terminal which supports 1T1R, 2T2R, or 4T4R, up to 2 SRS resource sets respectively configured with one SRS resource may be configured for SRS transmission. The number of SRS ports of each SRS resource may be configured to be 1, 2, or 4.

When indicated UE capability is 1T4R/2T4R, a corresponding terminal may expect that the same number of SRS ports (e.g., 1 or 2) will be configured for all SRS resources in SRS resource set(s). In addition, when indicated UE capability is 1T2R, 2T4R, 1T4R, or 1T4R/2T4R, a corresponding terminal may not expect that one or more SRS resource sets configured for antenna switching in the same slot will be configured or triggered. In addition, when indicated UE capability is 1T1R, 2T2R, or 4T4R, a corresponding terminal may not expect that one or more SRS resource sets configured for antenna switching in the same slot will be configured or triggered.

Method for Transmitting and Receiving Uplink Signals

Hereinafter, in the present disclosure, a method for a base station configuring transmission panel, beam, and/or pathloss reference signal (RS) of a terminal for each specific UL signal (i.e., a UL channel and/or UL reference signal (RS)) and a method for a terminal according thereto will be proposed.

The above contents (e.g., 3GPP system, frame structure, NR system, etc.) may be applied in combination with methods proposed in the present disclosure, which will be described later, alternatively, it may be supplemented to clarify the technical characteristics of the methods proposed in the present disclosure. In this document, ‘/’ means ‘and’, ‘or’, or ‘and/or’ depending on the context.

In Rel-15 NR, spatial relation information (i.e., higher layer parameter spatialRelationInfo) is used to configure/indicate a transmission beam to be used when a base station transmits a UL channel/RS to a terminal. That is, the base station may configur/indicate to the terminal, DL RS (e.g., SSB (i.e., SSB resource indication), CSI-RS (i.e., CSI-RS resource indication) (periodic (P)/semi-persistent (SP)/aperiodic (AP)) or UL RS (e.g., SRS (i.e., SRS resource indication)) as a reference RS for target UL channel and/or target RS, via a higher layer signaling (e.g., RRC configuration and/or MAC-control element (MAC-CE) activation). By doing this, the base station may configure/indicate which UL transmission beam (i.e., spatial Tx parameter) to utilize when the terminal transmits PUCCH and SRS. In addition, when the base station schedules the PUSCH for the terminal, the transmit beam used for SRS transmission (for codebook (CB) or non-codebook (NCB)) configured/updated/indicated by the base station may be indicated as a transmission beam for the PUSCH through the SRS resource indication (SRI) field of the UL grant DCI, and may be used as the PUSCH transmission beam of the terminal.

Meanwhile, UL-TCI will be described. As described above, an unified method for the base station to configure and indicate a transmission panel/beam for the UL channel/RS of the terminal may be considered. Existing (e.g., in Rel-15 NR) SRI-based PUSCH scheduling and PUSCH beam indication scheme, when the corresponding UL-TCI framework is applied, overhead and delay for PUSCH transmission beam configuration/indication may be reduced. In other words, this is because SRS transmission for the purpose of ‘CB’ or ‘non-CB’ does not necessarily need to be preceded for beam/panel indication for PUSCH transmission. In addition, the UL TCI-based scheme may be collectively applied to all UL channels/RSs such as PUCCH/PUSCH/SRS.

A pathloss (PL) RS configuration/update is described. In NR MIMO Rel-15, the base station may configure DL RS (i.e., pathloss RS (PL RS)) as an open loop power control parameter for pathloss compensation for UL channel/RS of the terminal (e.g., PUSCH, PUCCH, SRS). For example, for PUCCH, the base station may updates the pathloss RS (PL RS) by updating PUCCH spatial relation information (identifier) (higher layer parameter PUCCH-SpatialRelationInfold) through a MAC-CE message for each PUCCH resource. As described above, in the case of PL RS update for a specific UL channel/RS in Rel-16, for each channel/RS (e.g., PUCCH resource identifier (ID), SRS resource set identifier (SRS resource set ID), SRI identifier (SRI ID), etc.), PUCCH spatial relation information identifier (spatial relation info ID) or pathloss RS identifier (pathloss RS ID) has been updated through a single MAC-CE. In this operation, the number of PL RSs that can be simultaneously tracked by the terminal may be set up to 4 according to UE capability.

A MAC-CE update scheme is described. In order to change the PL RS more dynamically in Rel-16 NR MIMO, the following agreement has been introduced regarding an operation of activating/updating the PL RS based on MAC-CE.
i) Determining whether to support update of pathloss reference RS (PL RS) for power control for PUSCH and SRS through MAC-CE
   It is necessary to agree on the condition of whether the RS for pathloss (PL) follows the downlink RS in spatial relation
   It is necessary to agree on whether UL power control parameters for PUSCH may be activated through MAC-CE, when spatial relation of AP-SRS (aperiodic-SPS) for codebook (CB)/non-codebook (NCB) UL may be activated by MAC-CE
ii) A pathloss reference RS for PUSCH may be activated/updated through MAC CE.
   The MAC CE message may activate/update a value of PUSCH-pathloss reference RS identifier (i.e., higher layer parameter PUSCH-PathlossReferenceRS-Id) corresponding to the SRI-PUSCH Power Control Identifier (i.e., higher layer parameter sri-PUSCH-PowerControlId) (which is used as the codepoint in the SRI field of the DCI). In Here, a mapping that is a linkage between sri-PUSCH-PowerControlId and PUSCH-PathlossReferenceRS-Id is given by SRI-PUSCH power control (i.e., higher layer parameter SRI-PUSCH-PowerControl).
   Reuse higher layer filtered RSRP for pathloss measurement, with defining the applicable timing after the MAC CE.

Filtered RSRP value for previous pathloss RS will be used before the application time, which is the next slot after the 5th measurement sample, where the 1st measurement sample corresponds to be the 1st instance, 3 ms after sending ACK for the MAC CE.

This is only applicable for UEs supporting the number of RRC-configurable pathloss RSs larger than 4, and this is only for the case that the activated PL RS by the MAC CE is not tracked.

UE is only required to track the activated PL RS(s) if the configured PL RSs by RRC is greater than 4.

It is up to UE whether to update the filtered RSRP value for previous PL RS 3 ms after transmitting ACK for the MAC CE.
iii) Pathloss reference RS for aperiodic SRS (AP-SRS)/semi-persistent SRS (SP-SRS) may be activated/updated via a MAC CE.
   A UE may be configured with multiple pathloss RSs by RRC and one of them may be activated/updated via the MAC CE for a SRS resource set.
   Reuse higher layer filtered RSRP for pathloss measurement, with defining the applicable timing after the MAC CE.

Filtered RSRP value for previous pathloss RS will be used before the application time, which is the next slot after 5th measurement sample, where the 1st measurement sample corresponds to be the 1st instance, 3 ms after sending ACK for the MAC CE.

This is only applicable for UEs supporting the number of RRC-configurable pathloss RSs larger than 4, and this is only for the case that the activated PL RS by the MAC CE is not tracked.

UE is only required to track the activated PL RS(s) if the configured PL RSs by RRC is greater than 4.

It is up to UE whether to update the filtered RSRP value for previous PL RS 3 ms after sending ACK for the MAC CE.
iv) On power control for PUSCH, PUCCH, and SRS, the total number of maximum configurable pathloss RSs, in including those supported in Rel-15, by RRC is 64

Such pathloss reference signals are for configuration purpose only, and UE is still only required to track up to 4 pathloss RSs for any PUSCH, PUCCH, and SRS transmissions.

In here, “Up to 4 pathloss RSs” applies the total number of pathloss RSs for PUSCH, PUCCH, and SRS.
v) For the feature of MAC CE based pathloss RS updates for PUSCH/SRS in Rel-16,

Introduce a new RRC parameter to enable the feature of new MAC CE based pathloss RS updates for PUSCH/SRS. That is, PL RS update enable for PUSCH SRS (enablePLRSupdateForPUSCHSRS)
vi) when PL RS update enable for PUSCH SRS (enablePLRSupdateForPUSCHSRS) is configured, if a grant-based or grant-free PUSCH transmission is scheduled/activated by DCI format 0_1 that does not include a SRI field, the RS resource index q_{d} corresponding to PUSCH-pathloss reference RS identifier (i.e., higher layer parameter the PUSCH-PathlossReferenceRS-Id) mapped with SRI-PUSCH power control identifier (i.e., sri-PUSCH-PowerControlId)=0 is used for path-loss measurement of PUSCH transmission. In this case, UE expects to be configured with SRI-PUSCH power control (sri-PUSCH-PowerControl).
vii) The application timing for the newly activated PL RSs is the next slot that is 2 ms after the N^{th} measurement sample, where the 1st measurement sample corresponds to be the 1st instance, 3 ms after sending ACK for the MAC CE.

In here, the value of N may be discussed, if there is no agreement on introducing UE capability for the value of N, N is fixed to 5.

The application timing is applied to PUSCH, AP/SP-SRS and PUCCH.
viii) Pathloss reference RS for PUSCH may be activated/updated via a MAC CE
   The MAC CE message may activate/update the value of PUSCH-pathloss reference RS identifier (i.e., higher layer parameter PUSCH-PathlossReferenceRS-Id) corresponding to SRI-PUSCH power control identifier (i.e., higher layer parameter sri-PUSCH-PowerControlId).
   Reuse higher layer filtered RSRP for pathloss measurement, with defining the applicable timing after the MAC CE.

Filtered RSRP value for previous pathloss RS will be used before the application time, which is the next slot that is 2 ms after the N^{th} measurement sample, where the 1st measurement sample corresponds to the 1st instance, 3 ms after transmitting ACK for the MAC CE.

This is only applicable for UEs supporting the number of RRC-configurable pathloss RS(s) larger than 4, and this is only for the case that the activated PL RS by the MAC CE is not tracked.

UE is only required to track the activated PL RS(s) if the configured PL RSs by RRC is greater than 4.

It is up to UE whether to update the filtered RSRP value for previous PL RS 3 ms after sending ACK for the MAC CE.

The value of N may be discussed, if there is no agreement on introducing UE capability for the value of N, N is fixed to 5.
ix) Pathloss reference RS for aperiodic SRS (AP-SRS)/semi-persistent SRS (SP-SRS) may be activated/updated via a MAC CE.
   A UE may be configured with multiple pathloss RSs by RRC and one of them may be activated/updated via the MAC CE for a SRS resource set.
   Reuse higher layer filtered RSRP for pathloss measurement, with defining the applicable timing after the MAC CE.

Filtered RSRP value for previous pathloss RS will be used before the application time, which is the next slot that is 2 ms after N^{th} measurement sample, where the 1st measurement sample corresponds to be the 1st instance, 3 ms after sending ACK for the MAC CE.

This is only applicable for UEs supporting the number of RRC-configurable pathloss RSs larger than 4, and this is only for the case that the activated PL RS by the MAC CE is not tracked.

UE is only required to track the activated PL RS(s) if the configured PL RSs by RRC is greater than 4.

It is up to UE whether to update the filtered RSRP value for previous PL RS 3 ms after sending ACK for the MAC CE.

The value of N may be discussed, if there is no agreement on introducing UE capability for the value of N, N is fixed to 5.
x) When the number of RRC configured PL RSs for pathloss estimation for PUCCH, PUSCH and SRS is greater than 4, UE is not required to track the RSs which are not activated by MAC-CE.

If MAC-CE based PL RS activation/update is not enabled, UE is not expected to be configured with more than 4 PL RS.

Through the above description, spatial relation (i.e., UL transmission beam and/or panel) and PL RS may be updated through MAC-CE, respectively. However, independent operation must be performed for each RS (i.e., spatial relation RS, PL RS) indication. Accordingly, unified beam (and/or panel) change/update for channels/RS(s) other than the targeted target channel/RS is not possible with the corresponding operation.

Therefore, the present disclosure proposes a UL-TCI framework configuring method that simultaneously considers pathloss RS together with the UL transmission beam/panel indication method. The proposal(s) described below are only classified for convenience of description, and some configurations of one proposal may be substituted with configurations of other proposals or may be applied in combination with each other.

In addition, in the present disclosure, for convenience of description, a radio signal transmitted from a terminal to a base station (or network) will be collectively referred to as a UL channel/RS (i.e., UL channel, UL RS). Hereinafter, in the present disclosure, UL channel/RS may refer to only RS, only channel, or both RS and channel. For example, in the present disclosure, the UL channel/RS may include at least one of PUSCH, PUCCH, and/or SRS. In addition, it is not limited thereto, and the UL channel/RS may also be referred to as a UL signal.

In addition, for convenience of description in the present disclosure, configuration information related to a transmission beam (or spatial relation) of a UL signal is referred to as a UL transmission configuration indicator (TCI) (state) information/configuration, but is not limited thereto. That is, UL TCI (state) information/configuration may be referred to as other terms such as UL spatial relation information and transmission parameters for UL channel/RS. In other words, in the present disclosure, the UL TCI (state) configuration for the UL channel/RS (e.g., PUCCH, PUSCH, SRS, etc.) of the terminal may mean the configuration of the transmission beam (or spatial relation) for the UL channel/RS of the terminal.

In addition, in the present disclosure, spatial relation RS may mean a signal referred to for application of a transmission beam (or spatial relation) of a UL signal, and may also be referred to by terms such as a source RS, TCI (reference) RS, QCL (reference) RS (e.g., QCL type-D RS, etc.).

Embodiment 1: The base station may configure UL TCI information/configuration including all or part of a spatial relation RS/panel identifier (ID)/pathloss reference RS (PL RS) to the terminal, via higher layer signaling (e.g., RRC signaling, MAC CE, etc.).

Accordingly, when the terminal transmits a corresponding target UL channel/RS, the terminal may use a spatial relation RS configured to determine a transmission beam of the target UL channel/RS. In other words, when the terminal transmits a target UL channel/RS, the terminal may transmit a target UL channel/RS with the same spatial domain transmission filter as a spatial domain reception filter used for reception of a configured spatial relation reference RS (e.g., SSB, CSI-RS, etc.) or a spatial domain transmission filter used for transmission of the configured spatial relation reference RS (e.g., SRS, etc.). In other words, when transmitting a target UL channel/RS, the terminal may transmit a target UL channel/RS based on a spatial relation, with referring to the spatial relation reference RS (e.g., SSB, CSI-RS, etc.).

In addition, when transmitting a corresponding target UL channel/RS, the terminal may determine transmission power based on the configured PL RS. That is, the terminal may calculate the downlink pathloss estimation value calculated using the PL RS, and determine the transmission power of the corresponding target UL channel/RS based on this calculation.

Embodiment 1 means an unified UL TCI frame configuration for indicating a PL RS to be utilized/applied to power control (PC) for a corresponding transmission as well as a transmission beam and/or panel for a UL channel/RS. In here, the UL TCI state configuration for performing UL channel/RS transmission of the terminal may include panel ID, which is panel-related information of the terminal, and/or spatial relation RS, which is beam-related information, and/or pathloss reference RS (PL RS) information related to transmission power information may be included.

In Table 10 below, an embodiment of unified configuration of beam and PL RS for a target channel/RS through UL TCI configuration considering PL RS is as follows.

TABLE 10
For example, UL TCI state = {spatial relation RS, panel, PL RS}
PUCCH <− UL TCI #1 = {DL RS#1 (e.g., CSI-RS#1), panel#1, PL RS#1}
PUSCH <− UL TCI #2 = {UL RS#1 (e.g., SRS#1 for multi-beam), panel#2, PL RS#2}
SRS <− UL TCI #3 = {DL RS#2 (e.g., SSB#1), panel#2, PL RS#3}

Referring to Table 10, a case in which spatial relation RS, panel, and PL RS are configured in the UL TCI state is exemplified. However, the present disclosure is not limited thereto, and at least one or more of spatial relation RS, panel, and PL RS may be configured in the UL TCI state for the target UL channel/RS.

In addition, the panel and PL RS may be directly configured within the UL TCI state for the target UL channel/RS, and the panel and PL RS may be configured for the target UL channel/RS by including a higher layer information element (IE)/parameter related to the panel and PL RS in the UL TCI state.

In a PL RS-related operation, up to 64 RSs may be configured independently for each channel/RS in a pathloss RS pool that may be configured in a terminal. In addition, the number of PL RSs (N, where N is a natural number) that may be tracked at the same time is generally limited. Here, the maximum value (ie, N) may be configured by the base station or determined in advance. For example, the maximum value (ie, N) is 4 in general, and when configuring SRS for positioning, up to 16 PL RSs may be added according to UE capability. Therefore, the configuration of the PL RS pool may be different (independent) according to the target UL channel/RS, and the number of PL RSs configured for each target UL channel/RS may also be different. In addition, it is required to design a UL TCI configuration method that considers all matters for up to N (e.g., 4) PL RSs that may be tracked by the terminal. Alternatively, a physical cell identifier (PCI) may be considered along with the panel ID in the UL TCI configuration. That is, PCI associated with spatial relation info and/or PL RS in the UL TCI configuration may be included. In the case of positioning, a specific PCI may be configured in association with spatial relation info and/or PL RS in a multi-TRP (MTRP) situation, and this is because there may be cases in which the spatial relation and the PCI in which the PL RS are configured are different.

In here, a method of configuring PL RS related information in the UL TCI state configuration is as follows.
Option 1: The PL RS within the UL TCI state configuration may be configured as an identifier (ID) indicator (or index) for the PL RS(s) respectively configured for PUCCH/PUSCH/SRS.

For example, a PL RS pool consisting of one or more RS(s) may be configured for PUCCH. Here, a PL RS pool may be configured for each PUCCH resource or each PUCCH resource set. In addition, a PL RS pool consisting of one or more RS(s) may be configured for PUSCH. In addition, a PL RS pool consisting of one or more RS(s) may be configured for the SRS. Here, a PL RS pool may be configured for each SRS resource or each SRS resource set. Here, RSs included in the PL RS pool configured for each of PUCCH, PUSCH, and SRS may be different (some may be the same), and the number of RSs may also be different.

In the PL RS information configuration method of UL TCI configuration, an ID (or index, indicator) based on a PL RS pool configured for each channel/RS may be configured. This means that the terminal performs a power control (PC) related operation by being mapped to an RS ID for a PL RS pool of a specific channel/RS considered in the corresponding UL TCI configuration.

In other words, when a specific RS ID (or index, indicator) is indicated in the UL TCI state configuration for the target UL channel/RS, the RS identified by the RS ID (or index, indicator) may be applied/configured/updated as the PL RS of the target UL channel/RS within the PL RS pool for the target UL channel/RS.

For example, in the UL TCI configuration example, if ‘#10’ is indicated in the PL RS configuration field/parameter, the PL RS of the target/RS can be applied/configured/updated, with utilizing the 10th RS of each PL RS pool individually configured in the target PUCCH/PUSCH/SRS.

For example, if UL TCI state #1 is configured for PUCCH in Table 10, PL RS #1 may be indicated by UL TCI state #1. In this case, a RS having an identifier (or index) 1 (e.g., the first RS) in the PL RS pool of the PUCCH may be applied/configured/updated as a PL RS for the PUCCH.

As another example, if UL TCI state #3 is configured for PUCCH in Table 10, PL RS #3 may be indicated by UL TCI state #3. In this case, an RS (eg, a third RS) having an identifier (or index) 3 in the PL RS pool of PUCCH may be applied/configured/updated as a PL RS for PUCCH.

Meanwhile, in the above scheme, the number of PL RS(s) of the PL RS pool for each independently configured UL channel/RS may be different. Therefore, there may occur a case where the PL RS ID indicator (i.e., ID, index, indicator) indicated by the corresponding UL TCI state does not correspond. For example, this may correspond to the case where the size of the PL RS pool for a specific UL channel/RS is 8 (i.e., the number of RSs included in the PL RS pool is 8), but the ID for the PL RS in the UL TCI state indicates 10.

If the PL RS(s) configured for each UL channel/RS does not correspond to the corresponding ID indicator, it may be replaced/applied with an ID indicator according to the following methods.
Alternative 1: Based on pre-defined rules, the terminal may follow (use) the PL RS ID. That is, if the PL RS ID indicated in the UL TCI state configuration for a specific UL channel/RS is not included in the PL RS pool of the corresponding UL channel/RS, the PL RS may be configured according to the pre-defined rules, within the PL RS pool of the corresponding UL channel/RS. For example, a PL RS identified by the lowest or highest PL RS ID within the PL RS pool of the corresponding UL channel/RS may be configured.
Alternative 2: The terminal may not utilize the corresponding PL RS information. In this case, the terminal may follow (or use) a pre-configured PL RS. That is, if the PL RS ID indicated in the UL TCI state configuration for a specific UL channel/RS is not included in the PL RS pool of the corresponding UL channel/RS, the terminal may use a pre-configured PL RS for the corresponding UL channel/RS without following (i.e., ignoring) the UL TCI state configuration.
Alternative 3: The terminal may use the spatial relation RS in the corresponding UL TCI state as the PL RS, or may follow (use) the PL RS configured in the spatial relation RS. For example, in the example of Table 10 above, when PL RS #3 is configured in the UL TCI state configuration for SRS, the RS corresponding to identifier (or index) #3 in the PL RS pool of SRS may be not included. In this case, the terminal may use/apply DL RS #2 (e.g., SSB #1), which is a spatial relation RS in the corresponding UL TCI state configuration, as a PL RS for the SRS.

As another example, in the example of Table 10 above, when PL RS #2 is configured in the UL TCI state configuration for the PUSCH, the RS corresponding to the identifier (or index) #2 in the PL RS pool of the PUSCH may not be included. In this case, the terminal may use/apply the PL RS configured for SRS #1, which is a spatial relation RS in the corresponding UL TCI state configuration, as the PL RS for the PUSCH.

Alternatively, unlike alternatives 1 to 3 above, the terminal may not expect that the number of PL RS(s) configured for each channel/RS (i.e., the number of RS (s) in the PL RS pool) is different.
Option 2: A PL RS pool collectively configured for PUCCH/PUSCH/SRS may be configured, and an ID indicator (or index) for the corresponding PL RS pool may be configured.

For example, an unified PL RS pool may be configured for PUCCH/PUSCH/SRS (i.e., for all UL channels/RSs).

That is, instead of operating based on a previously configured PL RS pool for each UL channel/RS, an unified PL RS pool for UL channels/RSs may be separately configured. Additionally, the ID indicator for the unified PL RS pool may be configured/indicated in the PL RS field/parameter of the UL TCI state.

In other words, when a specific RS ID (or index, indicator) is indicated in the UL TCI state configuration for the target UL channel/RS, the RS RS identified by ID (or index, indicator) may be applied/configured/updated as the PL RS of the target UL channel/RS.

For example, if UL TCI state #1 is configured for PUCCH in Table 10, PL RS #1 may be indicated by UL TCI state #1. In this case, an RS having an identifier (or index) 1 (e.g., the first RS) in a PL RS pool collectively configured for UL channels/RSs may be applied/configured/updated as a PL RS for PUCCH.

As another example, if UL TCI state #3 is configured for PUCCH in Table 10, PL RS #3 may be indicated by UL TCI state #3. In this case, an RS having an identifier (or index) 3 (e.g., a third RS) in a PL RS pool collectively configured for UL channels/RSs may be applied/configured/updated as a PL RS for PUCCH.

Here, the PL RS pool may be configured for RRC-configured (or configurable) DL RS (e.g., SSB, CSI-RS, etc.), that is, all or part of the global DL RS. That is, a PL RS pool integrated with all or some of all DL RSs configurable as PL RSs may be configured.

Alternatively, an unified PL RS pool may be configured based on PL RS(s) for each UL channel/RS. For example, the unified PL RS pool may be configured in a simple merge form for all or some PL RS(s) of each PL RS pool for each UL channel/RS. As another example, the unified PL RS pool may be configured with up to N (e.g., 4) PL RSs activated for each UL channel/RS. As another example, an unified PL RS pool may be configured with RSs commonly configured in the PL RS pool for each UL channel/RS.
Option 3: A PL RS may be configured (implicitly/implicitly) by utilizing the spatial relation RS configured in the UL TCI state configuration.

In a state where fields/parameters for the corresponding PL RS are not explicitly configured in the UL TCI state configuration, the PL RS may be indicated according to the spatial relation RS configuration. That is, when the corresponding spatial relation RS is a DL RS (e.g., SSB, CSI-RS), the corresponding RS may be applied as a PL RS, and when the corresponding spatial relation RS is a UL RS (e.g., SRS), the corresponding RS may be applied as a PL RS of resource set that includes the corresponding UL RS resource.

For example, when CSI-RS #1 is configured as a spatial relation RS within the UL TCI state configuration for the PUSCH, the UE may use/apply the CSI-RS #1 as a PL RS for the corresponding PUSCH. As another example, when SRS #1 is configured as a spatial relation RS within the UL TCI state configuration for PUSCH, the UE may use/apply the PL RS configured for SRS #1 as the PL RS for the PUSCH.

Among the operations for each of the various options proposed above, for the method of option 2 or the method of applying PL RS when the DL RS is configured as the spatial relation RS in option 3, if the specified RS is not present in the PL RS pool of the target channel/RS may occur. For example, in the method of option 2 above, since the PL RS ID indicated in the UL TCI state configuration is identified in the integrated PL RS pool, if all of the PL RS pools for the target UL channel/RS are not included in the integrated PL RS pool, the PL RS identified by the PL RS ID indicated in the UL TCI state configuration may not be included in the PL RS pool for the target UL channel/RS. In addition, in the method of Option 2 above, when the spatial relation RS is the DL RS in the UL TCI state configuration, since the corresponding DL RS is configured as PL RS for the target UL channel/RS, the DL RS may not be included in the PL RS pool for the target UL channel/RS.

In this case, in the present disclosure, the maximum number of PL RSs [n] (n is a natural number, for example, up to 4), a differentiated operation according to the preset number of PL RSs will be proposed. In here, the maximum number [n] of all PL RSs that may be tracked by the UE may be configured by the base station or may be a pre-defined value.

That is, when the UL TCI is indicated according to the option 2 or option 3 scheme, if there is no RS assigned (/specified/designated) by the UL TCI in the PL RS(s) configured in the target channel/RS (i.e., the PS RS pool configured for the target channel/RS), it may operate as follows according to the number [n] of tracking PL RS(s) pre-configured in the terminal (up to 4).
i) If the total number of tracking PL RS(s) is less than [n], PL RS tracking may be additionally configured to the RS assigned by the UL TCI state configuration.

That is, if the total number of tracking PL RSs is less than [n] at the time of the corresponding UL TCI indication, tracking of the corresponding PL RS may be added to the target channel/RS. In other words, tracking for a assigned PL RS may be added/activated by configuring the UL TCI state for the target channel/RS. In addition, the PL RS assigned by the UL TCI state configuration may be added to the PL RS pool for the corresponding target channel/RS.
ii) On the other hand, if the total number of tracking PL RS(s) is [n], the terminal may perform PL RS tracking only for RSs assigned within the corresponding channel/RS or update tracking PL RS according to a pre-defined rule.

That is, at the time of the corresponding UL TCI indication, if the total number of tracking PL RSs is already [n], the terminal may operate to ignore the pre-configured tracking and perform only the PL RS tracking updated by the UL TCI state configuration. In addition, the base station may configure/indicate the terminal to operate in this way. In other words, tracking for the PL RS assigned by the UL TCI state configuration for the target channel/RS may be added/activated, and pre-configured tracking for the target channel/RS may be ignored/deactivated. In addition, the PL RS specified by the UL TCI state configuration may be added to the PL RS pool for the corresponding target channel/RS.

Alternatively, according to a pre-defined rule, a specific RS ID of one or more tracking PL RS(s) (i.e., a PL RS pool for the corresponding target channel/RS) configured for the corresponding target channel/RS may be changed/updated. That is, the terminal may change/update a specific RS ID (e.g., lowest or highest RS ID) of tracking PL RS(s) pre-configured for the corresponding target channel/RS) (i.e., a PL RS pool for the corresponding target channel/RS) as a PL RS assigned by the UL TCI state.

Alternatively, when indicating UL TCI, if there is no RS assigned by UL TCI in the PL RS (s) configured in the target channel/RS (i.e., the PL RS pool for the target channel/RS), the terminal may maintain the PL RS pre-configured to the target channel/RS. In this case, the terminal may ignore the PL RS assigned by the UL TCI state for the corresponding target channel/RS.

Alternatively, DL RSs (e.g., CSI-RS, SSB, etc.) may be grouped in advance for beam indication. In addition, a specific representative PL RS (e.g., a PL RS having the lowest or highest identifier (index)) within the group to which the PL RS assigned by the UL TCI state configuration belongs may be applied as the PL RS for the target UL channel/RS. That is, even if the first PL RS is assigned by the actual UL TCI state configuration, the terminal may consider that a specific representative second PL RS in the group to which the first PL RS assigned by the UL TCI state configuration belongs is assigned by the UL TCI state.

In here, grouping of DL RS may be configured by a base station, and grouping may be determined in advance.

For example, it is assumed that 10 RSs from CSI-RS #1 to CSI-RS #10 are grouped into one group, and the representative RS of this group is CSI-RS #1. It is assumed that CSI-RS #1, CSI-RS #2, and CSI-RS #5 to CSI-RS #10 are configured in the PL RS pool configured for a specific UL channel/RS and CSI-RS #3 is indicated as a PL RS in the UL TCI state configuration for the specific UL channel/RS. As such, if CSI-RS #3 is not present in the PL RS pool configured for the specific UL channel/RS, but CSI-RS #3 is indicated through the UL TCI state configuration, the terminal may consider that the PL RS indication according to the representative RS (i.e., CSI-RS #1) has been performed.

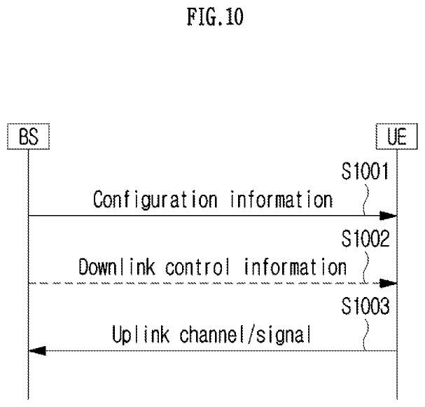

FIG. 10 is a diagram illustrating a signaling procedure between a base station and a user equipment (UE) for a method for transmitting and receiving an uplink signal according to an embodiment of the present disclosure.

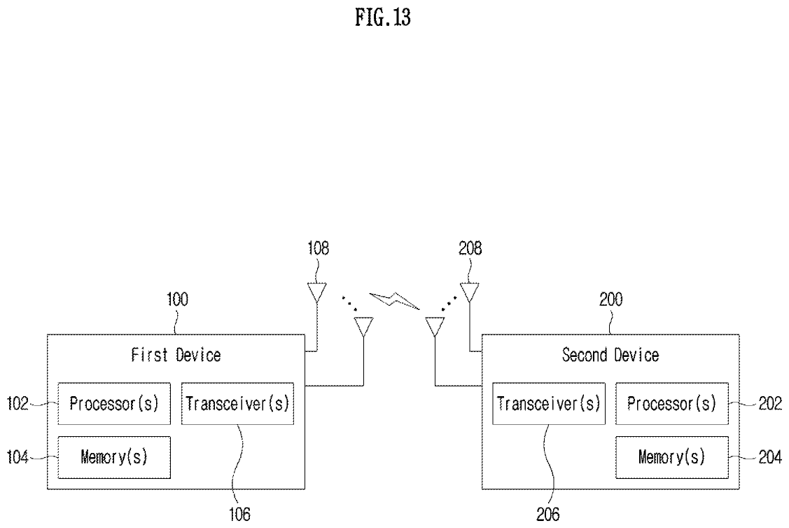

In FIG. 10, a signaling procedure between a UE and a base station based on the operation and detailed embodiments (at least one of options 1, 2, and 3) of the previously proposed embodiment 1 is exemplified. The example of FIG. 10 is for convenience of description, and does not limit the scope of the present disclosure. Some step(s) illustrated in FIG. 10 may be omitted depending on circumstances and/or configuration. In addition, the base station and the UE in FIG. 10 is only one example, and may be implemented as the apparatus illustrated in FIG. 13 below. For example, the processor 102/202 of FIG. 13 may control to transmit and receive channel/signal/data/information (e.g., RRC signaling, MAC CE, DCI for UL/DL scheduling, SRS, PDCCH, PDSCH, PUSCH, PUCCH, etc.) using the transceiver 106/206, and may control to store channel/signal/data/information to be transmitted or received in the memory 104/204.

Referring to FIG. 10, signaling between one base station and a UE is considered for convenience of description, but it goes without saying that the corresponding signaling scheme may extended and applied to signaling between multiple TRPs and multiple UEs. In the following description, a base station may be interpreted as one TRP. Alternatively, the base station may include a plurality of TRPs, or may be one cell including a plurality of TRPs.

In addition, “TRP” refers to a panel, an antenna array, a cell (e.g., macro cell/small cell/pico cell, etc.), TP (transmission point), base station (gNB, etc.).

Referring to FIG. 10, the base station (BS) may transmit configuration information related to transmission of an uplink signal (i.e., an uplink channel and/or a reference signal) to a user equipment (UE). (S1001). That is, the UE may receive configuration information related to transmission of an uplink signal from the base station.

The configuration information may be transmitted according to the above-described proposed method (e.g., at least one of operation and detailed options 1, 2, and 3 of the first embodiment).

In here, the uplink signal (i.e., uplink channel and/or reference signal) may mean one or more of PUSCH, PUCCH, and/or SRS.

The configuration information may include information (e.g., identifier, index) on a spatial relation RS for the uplink signal and/or information (e.g., identifier, index) on a pathloss (PL) RS for the uplink signal. That is, a spatial relation RS for the uplink signal and/or a pathloss RS for the uplink signal may be assigned/configured/updated/indicated by the configuration information. In here, assignment/configuration/update/indication of the spatial relation RS by the configuration information may mean that the UE is assigned/configured/updated/indicated to transmit the uplink signal with the same spatial domain transmission filter used when receiving the spatial relation RS signal. In addition, assignment/configuration/update/indication of the pathloss RS by the configuration information may mean that the UE is assigned/configured/updated/indicated to determine the transmit power of the uplink signal based on the estimated pathloss value calculated using the pathloss RS.

In addition, the configuration information may include information (e.g., an identifier, an index) on a panel for the uplink signal. That is, a panel for the uplink signal may be assigned/configured/updated/indicated by the configuration information.

Assignment/configuration/update/indication of a panel by the configuration information may mean that the UE is assigned/configured/updated/indicated to transmit the uplink signal through/using the panel.

As described above, the configuration information may mean single uplink signaling (e.g., single RRC signaling or RRC IE), and at least one of spatial relation RS, pathloss RS, and/or panel ID for the uplink signal may be assigned/configured/updated/indicated by the single uplink signaling. For example, the configuration information may be referred to as UL TCI state or spatial relation information.

For example, the configuration information may include an ID/index for specifying a spatial relation RS (hereinafter referred to as a first identifier) and/or an ID/index for specifying a pathloss RS (hereinafter referred to as a second identifier). That is, the spatial relation RS for the uplink signal may be assigned/configured/indicated by the first identifier of the spatial relation RS. Similarly, the pathloss RS for the uplink signal may be assigned/configured/indicated by the second identifier of the pathloss RS.

As in option 1 above, a pathloss RS pool consisting of one or more RS(s) may be configured for each uplink signal (e.g., PUSCH, PUCCH, SRS). And, the pathloss RS configured by the configuration information may be specified by a second identifier within a PL RS pool configured for the uplink signal. For example, a pathloss RS pool consisting of one or more RS(s) for each uplink signal (e.g., PUSCH, PUCCH, SRS) may be configured to the same size (i.e., the same number of pathloss RSs).

In here, if the pathloss RS configured by the configuration information in the pathloss RS pool configured for the uplink signal is not specified by the second identifier (i.e., when there is no the pathloss RS having the second identifier in the pathloss RS pool), a pathloss RS specified by a pre-determined identifier/index (e.g., highest or lowest identifier/index) in the pathloss RS pool configured for the uplink signal may be assigned/configured/indicated to the UE. Alternatively, if the pathloss RS configured by the configuration information in the pathloss RS pool configured for the uplink signal is not specified by the second identifier (i.e., when there is no the pathloss RS having the second identifier in the pathloss RS pool), a pathloss RS previously configured for the uplink signal (e.g., a pathloss RS already configured for the uplink signal prior to the configuration information) may be used. Alternatively, if the pathloss RS configured by the configuration information in the pathloss RS pool configured for the uplink signal is not specified by the second identifier (i.e., when there is no the pathloss RS having the second identifier in the pathloss RS pool), the assigned spatial relation RS in the configuration information (e.g., when the spatial relation RS is a downlink signal) may be configured as the pathloss RS for the uplink signal, or the pathloss RS of the assigned spatial relation RS in the configuration information (e.g., when spatial relation RS is an uplink signal) may be assigned/configured/indicated as the pathloss RS for the uplink signal.

In addition, as in option 2 above, a pathloss RS pool may be collectively configured for uplink signals (e.g., PUSCH, PUCCH, and SRS). In addition, the pathloss RS configured by the configuration information may be specified by a second identifier in the collectively configured pathloss RS pool. In here, the collectively configured pathloss RS pool may consist of one or more pathloss RSs activated for each uplink signal (e.g., PUCCH, PUSCH, SRS). Alternatively, the collectively configured pathloss RS pool may consist of one or more common pathloss RSs in the pathloss RS pool configured for each uplink signal (e.g., PUCCH, PUSCH, SRS).

Also, as in option 3 above, the pathloss RS may be implicitly assigned/configured/indicated by the configuration information. In other words, even if there is no separate information in the configuration information, the spatial relation RS in the configuration information (for example, when the spatial relation RS is a downlink signal) may be implicitly assigned/configured/indicated as a pathloss RS for the uplink signal, or the pathloss RS for the spatial relation RS (e.g., when the spatial relation RS is an uplink signal) may be implicitly assigned/configured/indicated as the pathloss RS for the uplink signal.

Also, as described above, in the case of option 2 or option 3, the pathloss RS assigned by the configuration information may not be included in the pathloss RS pool configured for the uplink signal. In this case, depending on the total number of pathloss RSs that are being tracked (i.e., activated) at the time that the terminal receives the configuration information, operations such as activation/configuration of pathloss RSs assigned/configured by the configuration information may vary.

For example, if the total number of PL RSs tracked by the terminal is less than N (N is a natural number) (where N may be configured by the base station or configured to a fixed value in advance), tracking of the pathloss RS assigned by the configuration information may be activated. That is, the pathloss RS assigned by the configuration information may be included in the pathloss RS tracked by the UE.

On the other hand, for example, if the total number of PL RSs tracked by the terminal is N (N is a natural number) (here, N may be configured by the base station or configured to a fixed value in advance), tracking of a PL RS assigned by the configuration information may be activated instead of tracking a pre-configured PL RS for the uplink signal. Alternatively, if the total number of PL RSs tracked by the terminal is N (N is a natural number) (here, N may be configured by the base station or configured to a fixed value in advance), a PL RS of a pre-determined identifier/index (e.g., a highest or lowest identifier/index) in a PL RS pool configured for the uplink signal may be updated/changed to the assigned PL RS. Alternatively, when the assigned PL RS is not included in the PL RS pool configured for the uplink signal, if the total number of PL RSs tracked by the terminal is N (N is a natural number) (here, N may be configured by the base station or configured to a fixed value in advance), the assigned PL RS may be regarded as a specific RS (e.g., a specific RS having a highest or lowest identifier/index) of a group to which the assigned PL RS belongs, by the configuration information. In here, grouping may be configured by the base station or a pre-fixed group may be determined for downlink signals.

The base station may transmit downlink control information to the UE (S1002). That is, the UE may receive downlink control information from the base station. Downlink control information may be transmitted in (through) the PDCCH.

If the uplink signal is a periodic SRS in step S1003, transmission and reception of downlink control information in step S1002 may be omitted.

Alternatively, when the uplink signal is semi-persistent SRS in step S1003, step S1002 may correspond to MAC CE triggering semi-persistent SRS.

Alternatively, the downlink control information may be UL grant DCI for scheduling the PUSCH, and in this case, the UE may transmit the PUSCH to the base station based on the scheduling information based on the UL grant DCI.

Alternatively, the downlink control information may be a DL grant DCI for scheduling the PDSCH, and in this case, although not shown, the UE may receive the PDSCH based on scheduling information based on the DL grant DCI from the base station. In addition, the UE may transmit a PUCCH carrying acknowledgment (ACK) information for the PDSCH to the base station.

The UE transmits an uplink signal (i.e., an uplink channel and/or a reference signal) to the base station (S1003).

The uplink signal may be transmitted according to the above-described proposed method (e.g., at least one of operation and detailed options 1, 2, and 3 of Embodiment 1).

In here, the uplink signal (i.e., uplink channel and/or reference signal) may mean one or more of PUSCH, PUCCH, and/or SRS.

If the uplink signal (i.e., uplink channel and/or reference signal) is PUSCH, downlink control information in step S1002 may correspond to UL grant DCI scheduling the corresponding PUSCH. The UE may transmit the PUSCH to the BS based on scheduling information by UL grant DCI.

In addition, when an uplink signal (i.e., an uplink channel and/or a reference signal) is a PUCCH, the PUCCH may carry uplink control information (e.g., ACK information for PDSCH, CSI, scheduling request (SR) etc.). In particular, when the uplink signal is a PUCCH carrying ACK information for the PDSCH, the downlink control information of step S1002 may correspond to a DL grant DCI scheduling the corresponding PDSCH. Additionally, a PUCCH resource on which the PUCCH is transmitted may be determined based on a PUCCH resource indicator (PRI) in the DCI.

In addition, when an uplink signal (i.e., an uplink channel and/or a reference signal) is an SRS, the SRS may be an aperiodic SRS, a semi-persistent SRS, or a periodic SRS. In the case of aperiodic SRS, SRS transmission may be triggered by the downlink control information of step S1002. Alternatively, in the case of semi-persistent SRS, SRS transmission may be triggered by the MAC CE of step S1002. Alternatively, in the case of periodic SRS, step S1002 may be omitted as described above.

The terminal may transmit an uplink signal (i.e., an uplink channel and/or reference signal) to the base station based on the configuration information. As described above, a spatial relation RS for the uplink signal and/or a pathloss RS for the uplink signal may be assigned by the configuration information. In here, the uplink signal may be transmitted through the same spatial domain transmission filter used for transmission and reception of the assigned spatial relation RS. In addition, transmission power of the uplink signal may be determined based on the assigned pathloss RS. That is, transmission power of the uplink signal may be determined based on a pathloss estimation value calculated using the pathloss RS.

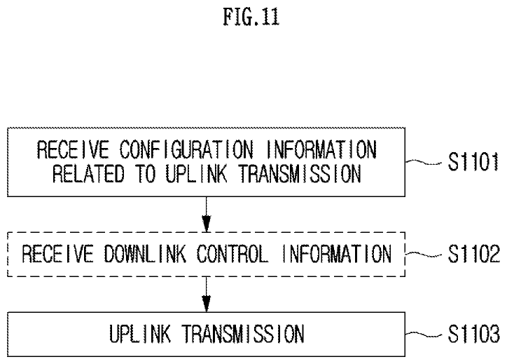

FIG. 11 illustrates an operation of a UE for transmitting an uplink signal according to an embodiment of the present disclosure.

In FIG. 11, an operation of a terminal based on the previously proposed methods (eg, the operation and at least one of detailed options 1, 2, and 3 of Embodiment 1). is exemplified. The example of FIG. 11 is for convenience of description, and does not limit the scope of the present disclosure. Some step(s) illustrated in FIG. 11 may be omitted depending on circumstances and/or configuration. In addition, the UE in FIG. 11 is only one example, and may be implemented as the apparatus illustrated in FIG. 13 below. For example, the processor 102/202 of FIG. 13 may control to transmit and receive channel/signal/data/information (e.g., RRC signaling, MAC CE, DCI for UL/DL scheduling, SRS, PDCCH, PDSCH, PUSCH, PUCCH, etc.) using the transceiver 106/206, and may control to store channel/signal/data/information to be transmitted or received in the memory 104/204.

Also, the operation of FIG. 11 may be processed by one or more processors (102, 202) in FIG. 13. Additionally, the operation of FIG. 11 may be stored in a memory (e.g., one or more memories (104, 204) in FIG. 13, in the form of instructions/programs (e.g., instructions, executable code) for driving at least one processor (102, 202) in FIG. 13.

Referring to FIG. 11, for convenience of explanation, an operation of a terminal for one base station (i.e., one TRP) is considered, but the operation of a UE may be extended and applied to an operation between multiple TRPs as well.

Referring to FIG. 11, a UE receives uplink/uplink signal (i.e., uplink channel and/or reference signal) configuration information from a base station (S1101).

The configuration information may be transmitted according to the above-described proposed method (e.g., at least one of operation and detailed options 1, 2, and 3 of the first embodiment).

In here, the uplink signal (i.e., uplink channel and/or reference signal) may mean one or more of PUSCH, PUCCH, and/or SRS.

The configuration information may include information (e.g., identifier, index) on a spatial relation RS for the uplink signal and/or information (e.g., identifier, index) on a pathloss (PL) RS for the uplink signal. That is, a spatial relation RS for the uplink signal and/or a pathloss RS for the uplink signal may be assigned/configured/updated/indicated by the configuration information. In here, assignment/configuration/update/indication of the spatial relation RS by the configuration information may mean that the UE is assigned/configured/updated/indicated to transmit the uplink signal with the same spatial domain transmission filter used when receiving the spatial relation RS signal. In addition, assignment/configuration/update/indication of the pathloss RS by the configuration information may mean that the UE is assigned/configured/updated/indicated to determine the transmit power of the uplink signal based on the estimated pathloss value calculated using the pathloss RS.

In addition, the configuration information may include information (e.g., an identifier, an index) on a panel for the uplink signal. That is, a panel for the uplink signal may be assigned/configured/updated/indicated by the configuration information.

Assignment/configuration/update/indication of a panel by the configuration information may mean that the UE is assigned/configured/updated/indicated to transmit the uplink signal through/using the panel.

As described above, the configuration information may mean single uplink signaling (e.g., single RRC signaling or RRC IE), and at least one of spatial relation RS, pathloss RS, and/or panel ID for the uplink signal may be assigned/configured/updated/indicated by the single uplink signaling. For example, the configuration information may be referred to as UL TCI state or spatial relation information.

For example, the configuration information may include an ID/index for specifying a spatial relation RS (hereinafter referred to as a first identifier) and/or an ID/index for specifying a pathloss RS (hereinafter referred to as a second identifier). That is, the spatial relation RS for the uplink signal may be assigned/configured/indicated by the first identifier of the spatial relation RS. Similarly, the pathloss RS for the uplink signal may be assigned/configured/indicated by the second identifier of the pathloss RS.

As in option 1 above, a pathloss RS pool consisting of one or more RS(s) may be configured for each uplink signal (e.g., PUSCH, PUCCH, SRS). And, the pathloss RS configured by the configuration information may be specified by a second identifier within a PL RS pool configured for the uplink signal. For example, a pathloss RS pool consisting of one or more RS(s) for each uplink signal (e.g., PUSCH, PUCCH, SRS) may be configured to the same size (i.e., the same number of pathloss RSs).

In here, if the pathloss RS configured by the configuration information in the pathloss RS pool configured for the uplink signal is not specified by the second identifier (i.e., when there is no the pathloss RS having the second identifier in the pathloss RS pool), a pathloss RS specified by a pre-determined identifier/index (e.g., highest or lowest identifier/index) in the pathloss RS pool configured for the uplink signal may be assigned/configured/indicated to the UE. Alternatively, if the pathloss RS configured by the configuration information in the pathloss RS pool configured for the uplink signal is not specified by the second identifier (i.e., when there is no the pathloss RS having the second identifier in the pathloss RS pool), a pathloss RS previously configured for the uplink signal (e.g., a pathloss RS already configured for the uplink signal prior to the configuration information) may be used. Alternatively, if the pathloss RS configured by the configuration information in the pathloss RS pool configured for the uplink signal is not specified by the second identifier (i.e., when there is no the pathloss RS having the second identifier in the pathloss RS pool), the assigned spatial relation RS in the configuration information (e.g., when the spatial relation RS is a downlink signal) may be configured as the pathloss RS for the uplink signal, or the pathloss RS of the assigned spatial relation RS in the configuration information (e.g., when spatial relation RS is an uplink signal) may be assigned/configured/indicated as the pathloss RS for the uplink signal.

In addition, as in option 2 above, a pathloss RS pool may be collectively configured for uplink signals (e.g., PUSCH, PUCCH, and SRS). In addition, the pathloss RS configured by the configuration information may be specified by a second identifier in the collectively configured pathloss RS pool. In here, the collectively configured pathloss RS pool may consist of one or more pathloss RSs activated for each uplink signal (e.g., PUCCH, PUSCH, SRS). Alternatively, the collectively configured pathloss RS pool may consist of one or more common pathloss RSs in the pathloss RS pool configured for each uplink signal (e.g., PUCCH, PUSCH, SRS).

Also, as in option 3 above, the pathloss RS may be implicitly assigned/configured/indicated by the configuration information. In other words, even if there is no separate information in the configuration information, the spatial relation RS in the configuration information (for example, when the spatial relation RS is a downlink signal) may be implicitly assigned/configured/indicated as a pathloss RS for the uplink signal, or the pathloss RS for the spatial relation RS (e.g., when the spatial relation RS is an uplink signal) may be implicitly assigned/configured/indicated as the pathloss RS for the uplink signal.

Also, as described above, in the case of option 2 or option 3, the pathloss RS assigned by the configuration information may not be included in the pathloss RS pool configured for the uplink signal. In this case, depending on the total number of pathloss RSs that are being tracked (i.e., activated) at the time that the terminal receives the configuration information, operations such as activation/configuration of pathloss RSs assigned/configured by the configuration information may vary.

For example, if the total number of PL RSs tracked by the terminal is less than N (N is a natural number) (where N may be configured by the base station or configured to a fixed value in advance), tracking of the pathloss RS assigned by the configuration information may be activated. That is, the pathloss RS assigned by the configuration information may be included in the pathloss RS tracked by the UE.

On the other hand, for example, if the total number of PL RSs tracked by the terminal is N (N is a natural number) (here, N may be configured by the base station or configured to a fixed value in advance), tracking of a PL RS assigned by the configuration information may be activated instead of tracking a pre-configured PL RS for the uplink signal. Alternatively, if the total number of PL RSs tracked by the terminal is N (N is a natural number) (here, N may be configured by the base station or configured to a fixed value in advance), a PL RS of a pre-determined identifier/index (e.g., a highest or lowest identifier/index) in a PL RS pool configured for the uplink signal may be updated/changed to the assigned PL RS. Alternatively, when the assigned PL RS is not included in the PL RS pool configured for the uplink signal, if the total number of PL RSs tracked by the terminal is N (N is a natural number) (here, N may be configured by the base station or configured to a fixed value in advance), the assigned PL RS may be regarded as a specific RS (e.g., a specific RS having a highest or lowest identifier/index) of a group to which the assigned PL RS belongs, by the configuration information. In here, grouping may be configured by the base station or a pre-fixed group may be determined for downlink signals.

The UE may receive downlink control information from the base station (S1102).

Downlink control information may be transmitted in (through) a PDCCH.

If the uplink signal is a periodic SRS in step S1103, transmission and reception of downlink control information in step S1102 may be omitted.

Alternatively, when the uplink signal is semi-persistent SRS in step S1103, step S1102 may correspond to MAC CE triggering semi-persistent SRS.

Alternatively, the downlink control information may be UL grant DCI for scheduling the PUSCH, and in this case, the UE may transmit the PUSCH to the base station based on the scheduling information based on the UL grant DCI.

Alternatively, the downlink control information may be a DL grant DCI for scheduling the PDSCH, and in this case, although not shown, the UE may receive the PDSCH based on scheduling information based on the DL grant DCI from the base station. In addition, the UE may transmit a PUCCH carrying acknowledgment (ACK) information for the PDSCH to the base station.

The UE transmits an uplink/uplink signal (i.e., an uplink channel and/or a reference signal) to the base station (S1103).

The uplink signal may be transmitted according to the above-described proposed method (e.g., at least one of operation and detailed options 1, 2, and 3 of Embodiment 1).

In here, the uplink signal (i.e., uplink channel and/or reference signal) may mean one or more of PUSCH, PUCCH, and/or SRS.

If the uplink signal (i.e., uplink channel and/or reference signal) is PUSCH, downlink control information in step S1102 may correspond to UL grant DCI scheduling the corresponding PUSCH. The UE may transmit the PUSCH to the BS based on scheduling information by UL grant DCI.

In addition, when an uplink signal (i.e., an uplink channel and/or a reference signal) is a PUCCH, the PUCCH may carry uplink control information (e.g., ACK information for PDSCH, CSI, scheduling request (SR) etc.). In particular, when the uplink signal is a PUCCH carrying ACK information for the PDSCH, the downlink control information of step S1102 may correspond to a DL grant DCI scheduling the corresponding PDSCH. Additionally, a PUCCH resource on which the PUCCH is transmitted may be determined based on a PUCCH resource indicator (PRI) in the DCI.

In addition, when an uplink signal (i.e., an uplink channel and/or a reference signal) is an SRS, the SRS may be an aperiodic SRS, a semi-persistent SRS, or a periodic SRS. In the case of aperiodic SRS, SRS transmission may be triggered by the downlink control information of step S1102. Alternatively, in the case of semi-persistent SRS, SRS transmission may be triggered by the MAC CE of step S1102. Alternatively, in the case of periodic SRS, step S1102 may be omitted as described above.

The UE may transmit an uplink signal (i.e., an uplink channel and/or reference signal) to the base station based on the configuration information. As described above, a spatial relation RS for the uplink signal and/or a pathloss RS for the uplink signal may be assigned by the configuration information. In here, the uplink signal may be transmitted through the same spatial domain transmission filter used for transmission and reception of the assigned spatial relation RS. In addition, transmission power of the uplink signal may be determined based on the assigned pathloss RS. That is, transmission power of the uplink signal may be determined based on a pathloss estimation value calculated using the pathloss RS.

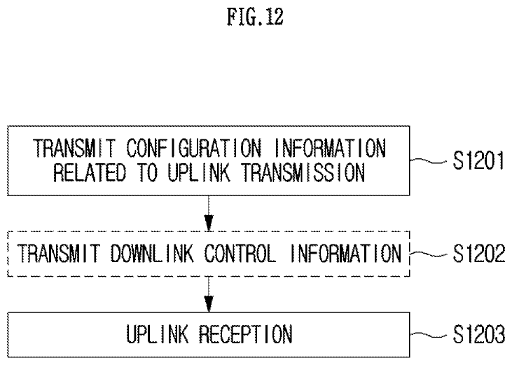

FIG. 12 illustrates an operation of a base station for receiving an uplink signal according to an embodiment of the present disclosure.

In FIG. 12, an operation of a terminal based on the previously proposed methods (eg, the operation and at least one of detailed options 1, 2, and 3 of Embodiment 1). is exemplified. The example of FIG. 12 is for convenience of description, and does not limit the scope of the present disclosure. Some step(s) illustrated in FIG. 12 may be omitted depending on circumstances and/or configuration. In addition, the base station in FIG. 12 is only one example, and may be implemented as the apparatus illustrated in FIG. 13 below. For example, the processor 102/202 of FIG. 13 may control to transmit and receive channel/signal/data/information (e.g., RRC signaling, MAC CE, DCI for UL/DL scheduling, SRS, PDCCH, PDSCH, PUSCH, PUCCH, etc.) using the transceiver 106/206, and may control to store channel/signal/data/information to be transmitted or received in the memory 104/204.

Also, the operation of FIG. 12 may be processed by one or more processors (102, 202) in FIG. 13. Additionally, the operation of FIG. 12 may be stored in a memory (e.g., one or more memories (104, 204) in FIG. 13, in the form of instructions/programs (e.g., instructions, executable code) for driving at least one processor (102, 202) in FIG. 13.

Referring to FIG. 12, for convenience of explanation, an operation of one base station (i.e., one TRP) is considered, but the operation may be extended and applied to an operation between multiple TRPs as well.

Referring to FIG. 12, the base station transmits uplink/uplink signal (i.e., uplink channel and/or reference signal) configuration information to a UE (S1201).

The configuration information may be transmitted according to the above-described proposed method (e.g., at least one of operation and detailed options 1, 2, and 3 of the first embodiment).

In here, the uplink signal (i.e., uplink channel and/or reference signal) may mean one or more of PUSCH, PUCCH, and/or SRS.

The configuration information may include information (e.g., identifier, index) on a spatial relation RS for the uplink signal and/or information (e.g., identifier, index) on a pathloss (PL) RS for the uplink signal. That is, a spatial relation RS for the uplink signal and/or a pathloss RS for the uplink signal may be assigned/configured/updated/indicated by the configuration information. In here, assignment/configuration/update/indication of the spatial relation RS by the configuration information may mean that the UE is assigned/configured/updated/indicated to transmit the uplink signal with the same spatial domain transmission filter used when receiving the spatial relation RS signal. In addition, assignment/configuration/update/indication of the pathloss RS by the configuration information may mean that the UE is assigned/configured/updated/indicated to determine the transmit power of the uplink signal based on the estimated pathloss value calculated using the pathloss RS.

In addition, the configuration information may include information (e.g., an identifier, an index) on a panel for the uplink signal. That is, a panel for the uplink signal may be assigned/configured/updated/indicated by the configuration information.

Assignment/configuration/update/indication of a panel by the configuration information may mean that the UE is assigned/configured/updated/indicated to transmit the uplink signal through/using the panel.

As described above, the configuration information may mean single uplink signaling (e.g., single RRC signaling or RRC IE), and at least one of spatial relation RS, pathloss RS, and/or panel ID for the uplink signal may be assigned/configured/updated/indicated by the single uplink signaling. For example, the configuration information may be referred to as UL TCI state or spatial relation information.

For example, the configuration information may include an ID/index for specifying a spatial relation RS (hereinafter referred to as a first identifier) and/or an ID/index for specifying a pathloss RS (hereinafter referred to as a second identifier). That is, the spatial relation RS for the uplink signal may be assigned/configured/indicated by the first identifier of the spatial relation RS. Similarly, the pathloss RS for the uplink signal may be assigned/configured/indicated by the second identifier of the pathloss RS.

As in option 1 above, a pathloss RS pool consisting of one or more RS(s) may be configured for each uplink signal (e.g., PUSCH, PUCCH, SRS). And, the pathloss RS configured by the configuration information may be specified by a second identifier within a PL RS pool configured for the uplink signal. For example, a pathloss RS pool consisting of one or more RS(s) for each uplink signal (e.g., PUSCH, PUCCH, SRS) may be configured to the same size (i.e., the same number of pathloss RSs).

In here, if the pathloss RS configured by the configuration information in the pathloss RS pool configured for the uplink signal is not specified by the second identifier (i.e., when there is no the pathloss RS having the second identifier in the pathloss RS pool), a pathloss RS specified by a pre-determined identifier/index (e.g., highest or lowest identifier/index) in the pathloss RS pool configured for the uplink signal may be assigned/configured/indicated to the UE. Alternatively, if the pathloss RS configured by the configuration information in the pathloss RS pool configured for the uplink signal is not specified by the second identifier (i.e., when there is no the pathloss RS having the second identifier in the pathloss RS pool), a pathloss RS previously configured for the uplink signal (e.g., a pathloss RS already configured for the uplink signal prior to the configuration information) may be used. Alternatively, if the pathloss RS configured by the configuration information in the pathloss RS pool configured for the uplink signal is not specified by the second identifier (i.e., when there is no the pathloss RS having the second identifier in the pathloss RS pool), the assigned spatial relation RS in the configuration information (e.g., when the spatial relation RS is a downlink signal) may be configured as the pathloss RS for the uplink signal, or the pathloss RS of the assigned spatial relation RS in the configuration information (e.g., when spatial relation RS is an uplink signal) may be assigned/configured/indicated as the pathloss RS for the uplink signal.

In addition, as in option 2 above, a pathloss RS pool may be collectively configured for uplink signals (e.g., PUSCH, PUCCH, and SRS). In addition, the pathloss RS configured by the configuration information may be specified by a second identifier in the collectively configured pathloss RS pool. In here, the collectively configured pathloss RS pool may consist of one or more pathloss RSs activated for each uplink signal (e.g., PUCCH, PUSCH, SRS). Alternatively, the collectively configured pathloss RS pool may consist of one or more common pathloss RSs in the pathloss RS pool configured for each uplink signal (e.g., PUCCH, PUSCH, SRS).

Also, as in option 3 above, the pathloss RS may be implicitly assigned/configured/indicated by the configuration information. In other words, even if there is no separate information in the configuration information, the spatial relation RS in the configuration information (for example, when the spatial relation RS is a downlink signal) may be implicitly assigned/configured/indicated as a pathloss RS for the uplink signal, or the pathloss RS for the spatial relation RS (e.g., when the spatial relation RS is an uplink signal) may be implicitly assigned/configured/indicated as the pathloss RS for the uplink signal.

Also, as described above, in the case of option 2 or option 3, the pathloss RS assigned by the configuration information may not be included in the pathloss RS pool configured for the uplink signal. In this case, depending on the total number of pathloss RSs that are being tracked (i.e., activated) at the time that the terminal receives the configuration information, operations such as activation/configuration of pathloss RSs assigned/configured by the configuration information may vary.

For example, if the total number of PL RSs tracked by the terminal is less than N (N is a natural number) (where N may be configured by the base station or configured to a fixed value in advance), tracking of the pathloss RS assigned by the configuration information may be activated. That is, the pathloss RS assigned by the configuration information may be included in the pathloss RS tracked by the UE.

On the other hand, for example, if the total number of PL RSs tracked by the terminal is N (N is a natural number) (here, N may be configured by the base station or configured to a fixed value in advance), tracking of a PL RS assigned by the configuration information may be activated instead of tracking a pre-configured PL RS for the uplink signal. Alternatively, if the total number of PL RSs tracked by the terminal is N (N is a natural number) (here, N may be configured by the base station or configured to a fixed value in advance), a PL RS of a pre-determined identifier/index (e.g., a highest or lowest identifier/index) in a PL RS pool configured for the uplink signal may be updated/changed to the assigned PL RS. Alternatively, when the assigned PL RS is not included in the PL RS pool configured for the uplink signal, if the total number of PL RSs tracked by the terminal is N (N is a natural number) (here, N may be configured by the base station or configured to a fixed value in advance), the assigned PL RS may be regarded as a specific RS (e.g., a specific RS having a highest or lowest identifier/index) of a group to which the assigned PL RS belongs, by the configuration information. In here, grouping may be configured by the base station or a pre-fixed group may be determined for downlink signals.

The base station may transmit downlink control information to the UE (S1202).

Downlink control information may be transmitted in (through) a PDCCH.

If the uplink signal is a periodic SRS in step S1203, transmission and reception of downlink control information in step S1202 may be omitted.

Alternatively, when the uplink signal is semi-persistent SRS in step S1203, step S1202 may correspond to MAC CE triggering semi-persistent SRS.

Alternatively, the downlink control information may be UL grant DCI for scheduling the PUSCH, and in this case, the base station may receive the PUSCH from the UE based on the scheduling information based on the UL grant DCI.

Alternatively, the downlink control information may be a DL grant DCI for scheduling the PDSCH, and in this case, although not shown, the base station may transmit the PDSCH based on scheduling information based on the DL grant DCI to the UE. In addition, the base station may receive a PUCCH carrying acknowledgment (ACK) information for the PDSCH from the UE.

The base station receives an uplink/uplink signal (i.e., an uplink channel and/or a reference signal) from the UE (S1103).

The uplink signal may be transmitted according to the above-described proposed method (e.g., at least one of operation and detailed options 1, 2, and 3 of Embodiment 1).

In here, the uplink signal (i.e., uplink channel and/or reference signal) may mean one or more of PUSCH, PUCCH, and/or SRS.

If the uplink signal (i.e., uplink channel and/or reference signal) is PUSCH, downlink control information in step S1202 may correspond to UL grant DCI scheduling the corresponding PUSCH. The base station may receive the PUSCH from the UE based on scheduling information by UL grant DCI.

In addition, when an uplink signal (i.e., an uplink channel and/or a reference signal) is a PUCCH, the PUCCH may carry uplink control information (e.g., ACK information for PDSCH, CSI, scheduling request (SR) etc.). In particular, when the uplink signal is a PUCCH carrying ACK information for the PDSCH, the downlink control information of step S1202 may correspond to a DL grant DCI scheduling the corresponding PDSCH. Additionally, a PUCCH resource on which the PUCCH is transmitted may be determined based on a PUCCH resource indicator (PRI) in the DCI.

In addition, when an uplink signal (i.e., an uplink channel and/or a reference signal) is an SRS, the SRS may be an aperiodic SRS, a semi-persistent SRS, or a periodic SRS. In the case of aperiodic SRS, SRS transmission may be triggered by the downlink control information of step S1202. Alternatively, in the case of semi-persistent SRS, SRS transmission may be triggered by the MAC CE of step S1202. Alternatively, in the case of periodic SRS, step S1202 may be omitted as described above.

The base station may receive an uplink signal (i.e., an uplink channel and/or reference signal) from the UE based on the configuration information. As described above, a spatial relation RS for the uplink signal and/or a pathloss RS for the uplink signal may be assigned by the configuration information. In here, the uplink signal may be transmitted through the same spatial domain transmission filter used for transmission and reception of the assigned spatial relation RS. In addition, transmission power of the uplink signal may be determined based on the assigned pathloss RS. That is, transmission power of the uplink signal may be determined based on a pathloss estimation value calculated using the pathloss RS.

General Device to which the Present Disclosure May be Applied

FIG. 28 illustrates a block diagram of a wireless communication device according to an embodiment of the present disclosure.

In reference to FIG. 28, a first wireless device 100 and a second wireless device 200 may transmit and receive a wireless signal through a variety of radio access technologies (e.g., LTE, NR).

A first wireless device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second wireless device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a wireless device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts disclosed in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefor, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a wireless device 100, 200 of the present disclosure may include Narrowband Internet of Things for a low-power communication as well as LTE, NR and 6G. Here, for example, an NB-IoT technology may be an example of a LPWAN (Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device XXX, YYY of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device XXX, YYY of the present disclosure may include at least any one of a ZigBee, a Bluetooth and a low power wide area network (LPWAN) considering a low-power communication and it is not limited to the above-described name. In an example, a ZigBee technology may generate PAN (personal area networks) related to a small/low-power digital communication based on a variety of standards such as IEEE 802.15.4, etc. and may be referred to as a variety of names.

A method proposed by the present disclosure is mainly described based on an example applied to 3GPP LTE/LTE-A, 5G system, but may be applied to various wireless communication systems other than the 3GPP LTE/LTE-A, 5G system.

1. A method performed by a terminal comprising:
receiving configuration information related to transmission of an uplink signal from a base station; and
transmitting the uplink signal to the base station based on the configuration information;
wherein a spatial relation reference signal (RS) for the uplink signal and a pathloss (PL) RS for the uplink signal are assigned by the configuration information,
wherein the uplink signal is transmitted through the same spatial domain transmission filter used for transmission and reception of the assigned spatial relation RS, and
wherein a transmission power of the uplink signal is determined based on the assigned PL RS.

2. The method of claim 1,
wherein the configuration information includes a first identifier for specifying the assigned spatial relation RS and a second identifier for specifying the assigned PL RS.

3. The method of claim 2,
wherein the assigned PL RS is specified by the second identifier in a PL RS pool configured for the uplink signal.

4. The method of claim 3,
wherein, when the assigned PL RS is not specified by the second identifier in the PL RS pool configured for the uplink signal, the assigned PL RS is specified by a pre-determined identifier in the PL RS pool configured for the uplink signal.

5. The method of claim 3,
wherein, when the assigned PL RS is not specified by the second identifier in the PL RS pool configured for the uplink signal, a pre-configured PL RS for the uplink signal is used as the assigned PL RS.

6. The method of claim 3,
wherein, when the assigned PL RS is not specified by the second identifier in the PL RS pool configured for the uplink signal, the assigned spatial relation RS or a PL RS for the assigned spatial relation RS is applied as the assigned PL RS.

7. The method of claim 3,
wherein the uplink signal includes a physical uplink control channel (PUCCH), a physical uplink shared channel (PUSCH), and a sounding reference signal (SRS),
wherein a PL RS pool of the same size is configured for the PUCCH, the PUSCH, and the SRS, respectively.

8. The method of claim 2,
wherein the uplink signal includes a physical uplink control channel (PUCCH), a physical uplink shared channel (PUSCH), and a sounding reference signal (SRS),
wherein the assigned PL RS is specified by the second identifier in a PL RS pool collectively configured for the PUCCH, the PUSCH, and the SRS.

9. The method of claim 8,
wherein the collectively configured PL RS pool includes one or more PL RSs activated for each of the PUCCH, the PUSCH, and the SRS.

10. The method of claim 8,
wherein the collectively configured PL RS pool includes one or more common PL RSs in a PL RS pool configured for each of the PUCCH, the PUSCH, and the SRS.

11. The method of claim 1,
wherein the assigned spatial relation RS or a PL RS for the assigned spatial relation RS is applied as the assigned PL RS.

12. The method of claim 8,
wherein, when the assigned PL RS is not included in a PL RS pool configured for the uplink signal and the total number of PL RSs tracked by the terminal is less than N (N is a natural number), tracking for the assigned PL is activated.

13. The method of claim 8,
wherein, when the assigned PL RS is not included in a PL RS pool configured for the uplink signal and the total number of PL RSs tracked by the terminal is N (N is a natural number), tracking for the assigned PL RS is activated instead of tracking for a pre-configured PL RS for the uplink signal.

14. The method of claim 8,
wherein, when the assigned PL RS is not included in a PL RS pool configured for the uplink signal and the total number of PL RSs tracked by the terminal is N (N is a natural number), a PL RS of a pre-determined identifier in the PL RS pool configured for the uplink signal is updated to the assigned PL RS.

15. The method of claim 8,
wherein, when the assigned PL RS is not included in a PL RS pool configured for the uplink signal and the total number of PL RSs tracked by the terminal is N (N is a natural number), the assigned PL RS is regarded as a specific RS of a group to which the assigned PL RS belongs.

16. The method of claim 1,
wherein a panel related to transmission of the uplink signal is further assigned by the configuration information.

17. A terminal in a wireless communication system, the terminal comprising:
at least one transceiver for transmitting and receiving a wireless signal; and
at least one processor for controlling the at least one transceiver,
wherein the at least one processor configured to:
receive configuration information related to transmission of an uplink signal from a base station; and
transmit the uplink signal to the base station based on the configuration information;
wherein a spatial relation reference signal (RS) for the uplink signal and a pathloss (PL) RS for the uplink signal are assigned by the configuration information,
wherein the uplink signal is transmitted through the same spatial domain transmission filter used for transmission and reception of the assigned spatial relation RS, and
wherein a transmission power of the uplink signal is determined based on the assigned PL RS.

18-20. (canceled)

21. A base station in a wireless communication system, the base station comprising:
at least one transceiver for transmitting and receiving a wireless signal; and
at least one processor for controlling the at least one transceiver,
wherein the at least one processor configured to:
transmit configuration information related to transmission of an uplink signal to a terminal; and
receive the uplink signal from the base station;
wherein a spatial relation reference signal (RS) for the uplink signal and a pathloss (PL) RS for the uplink signal are assigned by the configuration information,
wherein the uplink signal is transmitted through the same spatial domain transmission filter used for transmission and reception of the assigned spatial relation RS, and
wherein a transmission power of the uplink signal is determined based on the assigned PL RS.
